(19) United States
(12) Patent Application Publication
(10) Pub. No.: US 2025/0181213 A1
(43) Pub. Date: Jun. 5, 2025

(54) DISPLAY METHOD, INFORMATION PROCESSING APPARATUS, PROGRAM FOR DISPLAYING FUNCTION/OPERATION OF APPLIANCE

(71) Applicant: Panasonic Intellectual Property Corporation of America, Torrance, CA (US)

(72) Inventors: Tatsuhiro KISHI, Kanagawa (JP); Naoki TANAKA, Osaka (JP); Masashi OTANI, Osaka (JP)

(73) Assignee: Panasonic Intellectual Property Corporation of America, Torrance, CA (US)

(21) Appl. No.: 19/046,106

(22) Filed: Feb. 5, 2025

Related U.S. Application Data
(63) Continuation of application No. PCT/JP2023/029810, filed on Aug. 18, 2023.

(30) Foreign Application Priority Data
Aug. 24, 2022 (JP) 2022-133310

(51) Int. Cl. G06F 3/0482; G06F 9/451

(52) U.S. Cl. CPC G06F 3/0482; G06F 9/451

(57) ABSTRACT

In an appliance control system, a user apparatus, a sequence creation apparatus, and an information processing apparatus are connected via a network. The information processing apparatus includes a main processing unit. The main processing unit acquires an evaluation formula in which one or a plurality of functions representing a step executed by an appliance or a person and receiving a start condition, an execution parameter, and a completion condition as input variables are arranged. The main processing unit displays information related to the step in a step by step manner, based on one or a plurality of functions included in the evaluation formula acquired.

This application is based upon and claims the benefit of priority from the prior Japanese Patent Application No. 2022-133310, filed on Aug. 24, 2022, the entire contents of which are incorporated herein by reference.

### BACKGROUND

### 1. Field

The present disclosure relates to information processing technology and, particularly, to a display method, an information processing apparatus, and a program for displaying the function/operation of an appliance.

### 2. Description of the Related Art

For improvement of convenience of users of a cooker by communication technology, a cooker transmits a request for provision of recipe information related to the procedure for making a dish using the cooker, an information provision server provides the recipe information to a terminal apparatus upon receiving, the request for provision, and the terminal apparatus presents the recipe information (e.g., Patent Literature 1).

[Patent Literature 1 JP2021-48431

Appliances such as cookers are controlled by software. By updating the software, the appliance can realize various functions/operations. If such software is created or updated by a user, the appliance can execute a function/operation as desired by the user. Since the user often does not fully understand the relationship between the function/operation of the appliance and the software, however, the difficulty of creating or updating the software by the user increases. It is desirable to inform the user of the relationship between the function/operation of the appliance and the software in an easy-to-understand manner to make it easier for the user to create or update the software.

### SUMMARY

The present disclosure addresses the issue described above, and a purpose thereof is to provide a technology for displaying the function/operation of an appliance in an easy-to-understand manner.

A display method according to an embodiment of the present disclosure includes: acquiring an evaluation formula in which one or a plurality of functions representing a step executed by an appliance or a person and receiving a start condition, an execution parameter, and a completion condition as input variables are arranged; and displaying information related to the step in a step by step manner, based on one or a plurality of functions included in the evaluation formula acquired.

Another embodiment related to an information processing apparatus. The apparatus includes: a first processing unit that acquires an evaluation formula in which one or a plurality of functions representing a step executed by an appliance or a person and receiving a start condition, an execution parameter, and a completion condition as input variables are arranged; and a second processing unit that displays information related to the step in a step by step manner, based on one or a plurality of functions included in the evaluation formula acquired.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1A-1G show a configuration of an appliance control system according to the embodiment;

FIGS. 2A-2E show a configuration of the functional block used in the appliance control system of FIGS. 1A-1G;

FIGS. 3A-3H show a configuration of the functional block sequence used in the appliance control system of FIGS. 1A-1G;

FIG. 4 shows an overview of the operation of the appliance of FIGS. 1A-1G;

FIGS. 5A-5D show various representations of the functional block sequence in the appliance control system of FIGS. 1A-1G;

FIG. 6 shows a specific example of the function of FIG. 5B;

FIG. 7 shows another specific example of function of FIG. 5B;

FIG. 8 shows the evaluation formula derived from changing a part of the evaluation formula of FIG. 5B;

FIG. 9 shows a specific example of the functional block sequence in the appliance control system of FIGS. 1A-1G;

FIG. 10 shows the evaluation formula for the functional block sequence of FIG. 9;

FIG. 11 shows a configuration of the appliance control system of FIGS. 1A-1G;

FIG. 12 shows a configuration of the appliance of FIG. 11;

FIG. 13 shows a configuration of the sequence creation apparatus of FIG. 11;

FIG. 14 shows a configuration of the information processing apparatus of FIG. 11;

FIG. 15 shows a configuration of the user apparatus of FIG. 11;

FIGS. 16A-16C show a sequence creation IF displayed on the display unit of FIG. 13;

FIG. 17 is a sequence chart showing a display procedure executed by the appliance control system of FIG. 2;

FIGS. 18A-18C show the sequence display IF displayed on the display unit of FIG. 15;

FIGS. 19A-19B show display in the ingredient display area of FIG. 18A;

FIG. 20 is a sequence chart showing a display procedure executed by the appliance control system of FIG. 2;

FIGS. 21A-21C show the sequence display IF displayed on the display unit of FIG. 15;

FIG. 22 shows a sequence display IF displayed on the display unit of FIG. 15;

FIGS. 23A-23C show exemplary images displayed on the display unit of FIG. 15;

FIGS. 24A-24E show exemplary images displayed on the display unit of FIG. 15;

FIGS. 25A-25E show exemplary images displayed on the display unit of FIG. 15;

FIGS. 26A-26B show exemplary images displayed on the display unit 152 of FIG. 15; and

FIGS. 27A-27B show an appearance of the user apparatus of FIG. 15.

### DETAILED DESCRIPTION

The invention will now be described by reference to the preferred embodiments. This does not intend to limit the scope of the present invention, but to exemplify the invention.

All of the embodiments described below illustrate preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features illustrated in the figures are denoted by identical symbols, and a duplicate description is omitted or simplified. Hereinafter, the embodiment is described in the order of: (1) overview of functional block and functional block sequence, (2) evaluation formula and image representation of functional block sequence, (3) configuration of appliance control system, (4) creation of functional block sequence, (5) update to functional block sequence, (6) execution of intended process, and (7) a variation.

### (1) Overview of Functional Block and Functional Block Sequence

In household electrical/mechanical appliances such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

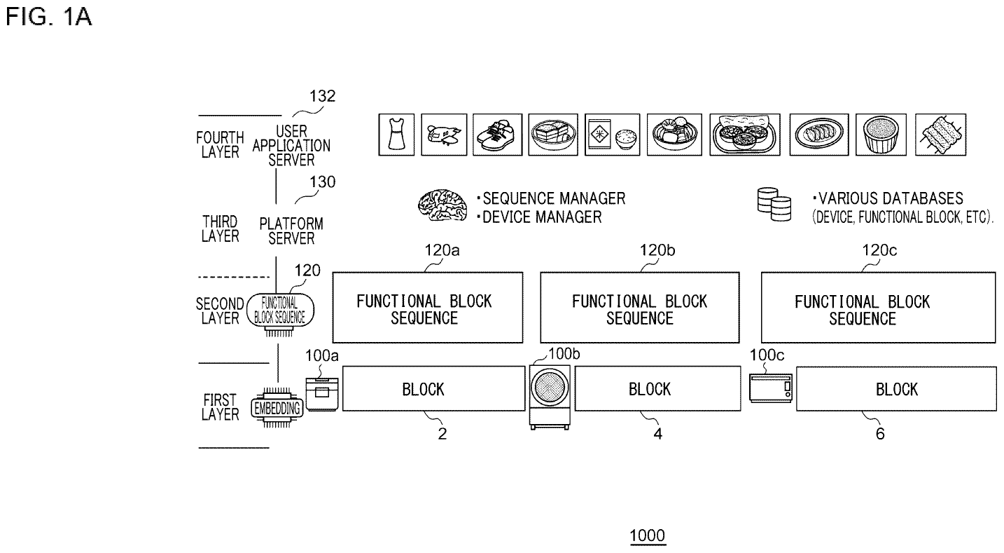

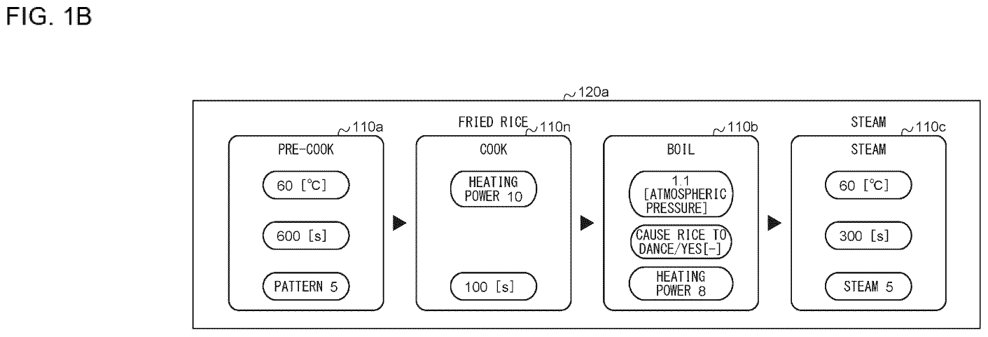

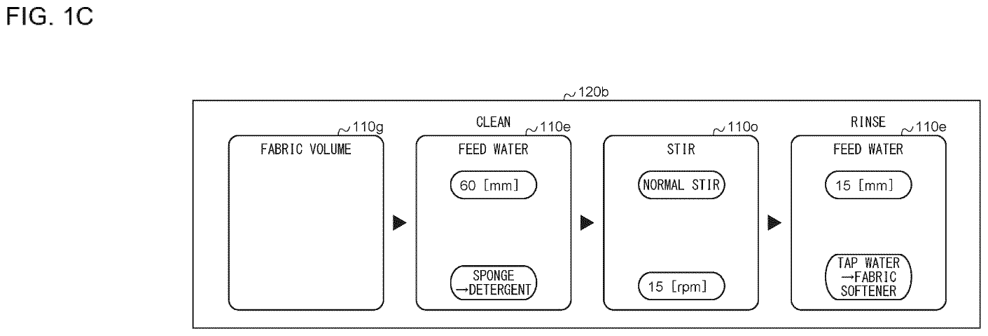

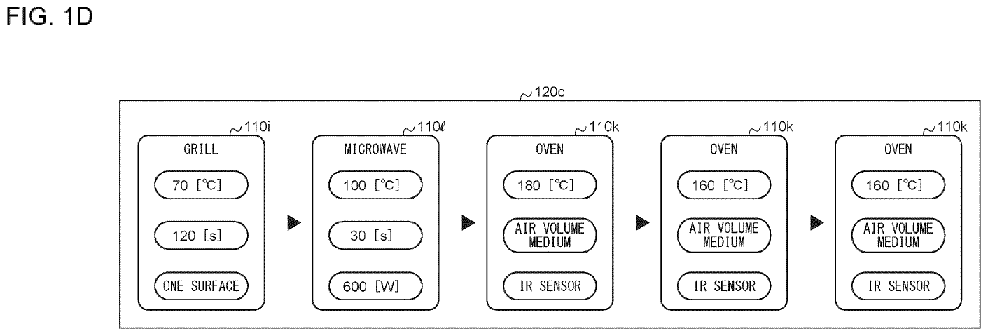

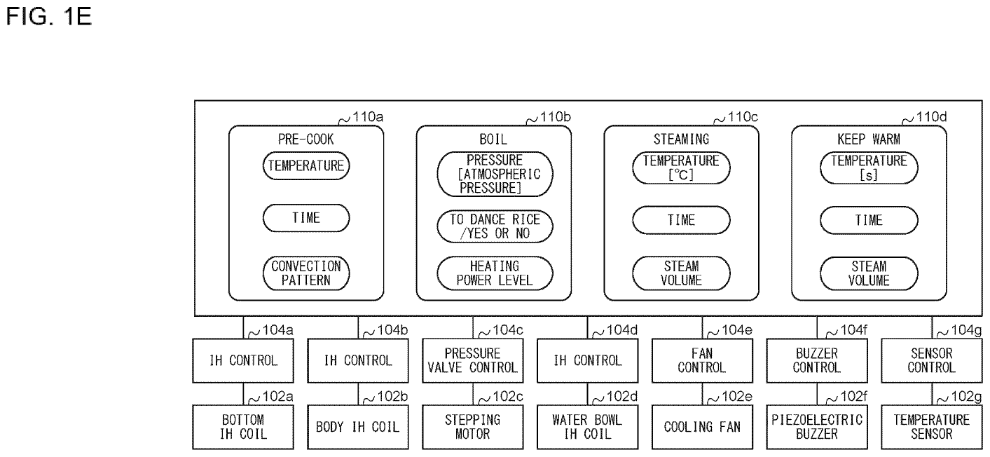

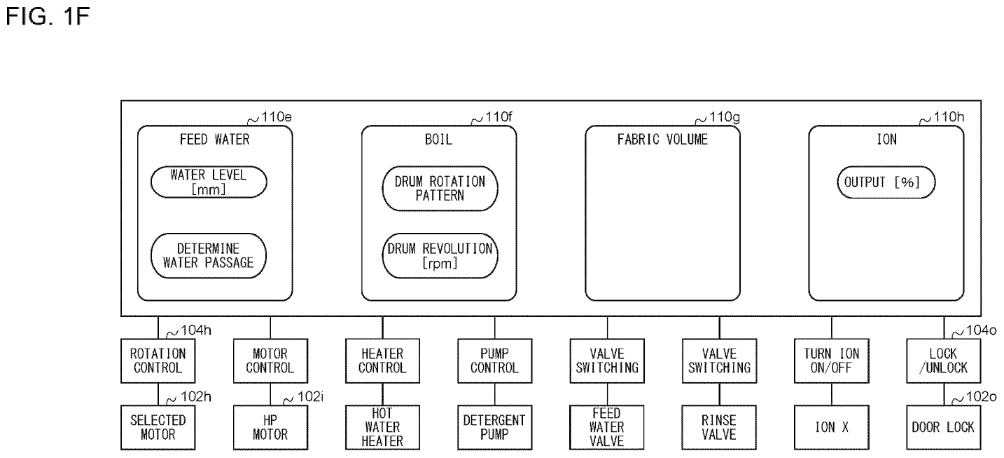

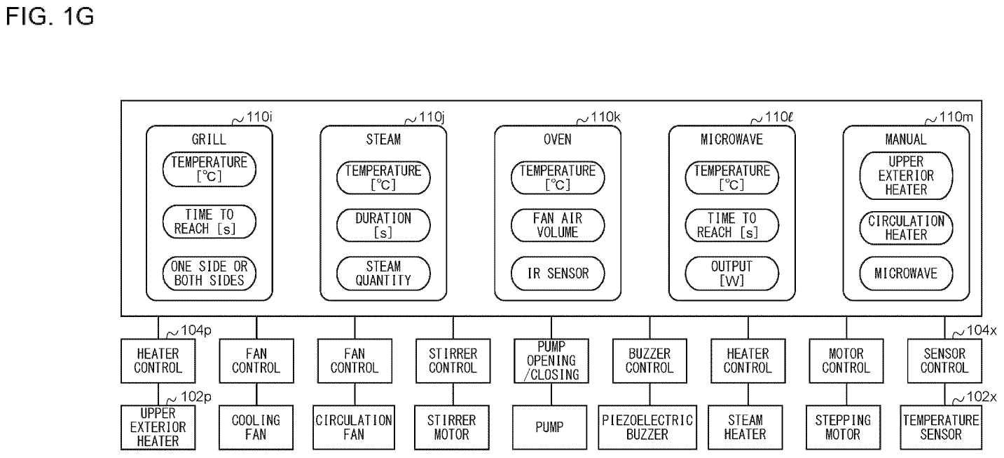

FIGS. 1A-1G show a configuration of an appliance control system 1000. In the appliance control system 1000, a four-layer model composed of the first to fourth layers is defined. In the first layer, the configuration of the appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 1E), a block 4 (FIG. 1F), a block 6 (FIG. 1G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102F) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 in which one or more functional blocks 110 are arranged in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 1B) is used in the rice cooker (appliance 100a), the functional block sequence 120b (FIG. 1C) is used in the washing machine (appliance 100b), and the functional block sequence 120c (FIG. 1D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the appliance control system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the appliance control system 1000 may be integrated. In that process, the platform server 130 and the user application server 132 are Alternatively, the third and fourth integrally configured. layers in the appliance control system 1000 may be arranged in the same layer. Alternatively, the third and fourth layers in the appliance control system 1000 may be omitted. In that process, the functional block sequence 120 is downloaded to the appliance 100 from the user apparatus (not shown) owned by the user.

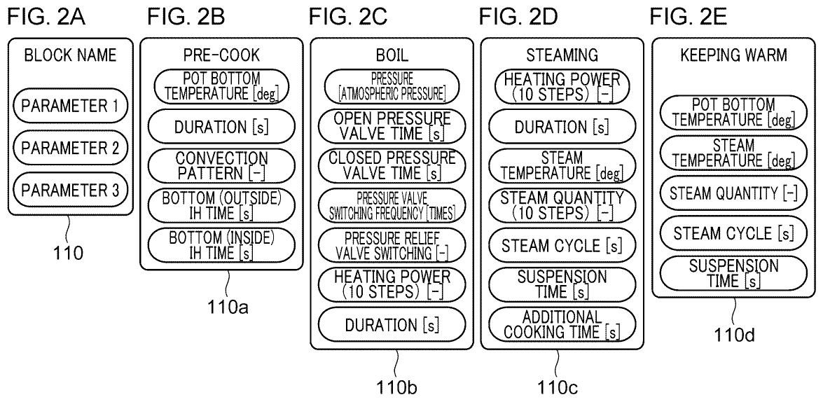

FIGS. 2A-2E show a configuration of the functional block 110 used in the appliance control system 1000. FIG. 2A shows the basic configuration of the functional block 110. The functional block 110 is defined in a functional unit that the appliance 100 can execute and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

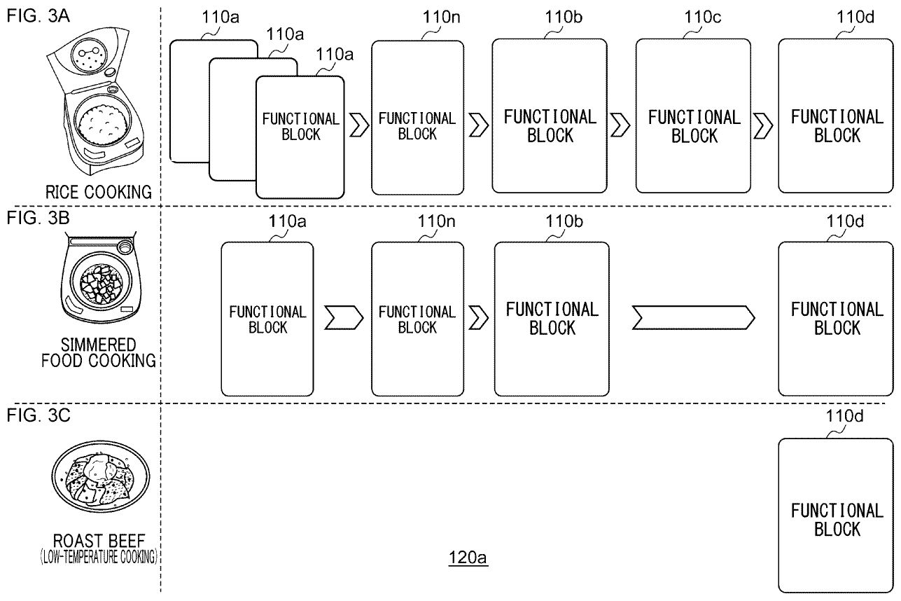

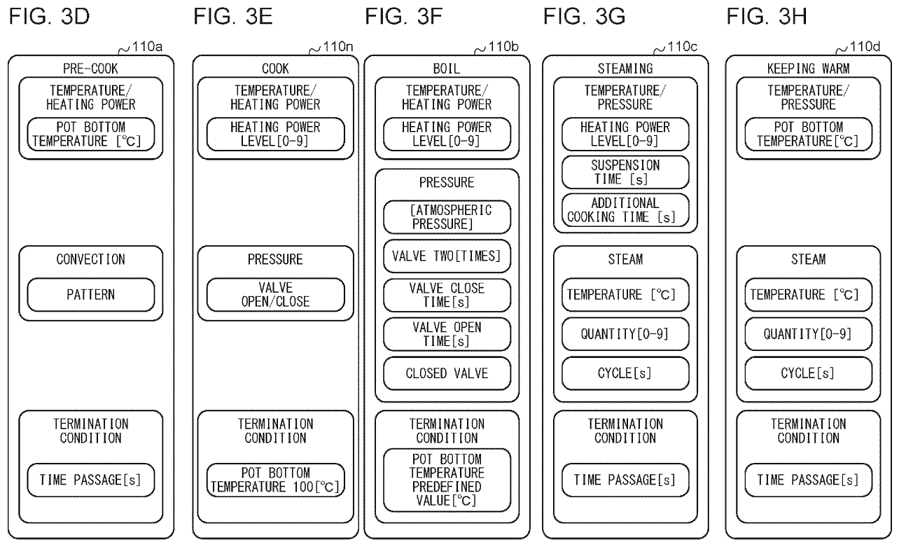

FIGS. 3A-3H show a configuration of the functional block sequence 120 used in the appliance control system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking)”. The same applies to the functional block sequence 120 in the washing machine (appliance 100b) and the microwave oven (appliance 100c) of FIG. 1A.

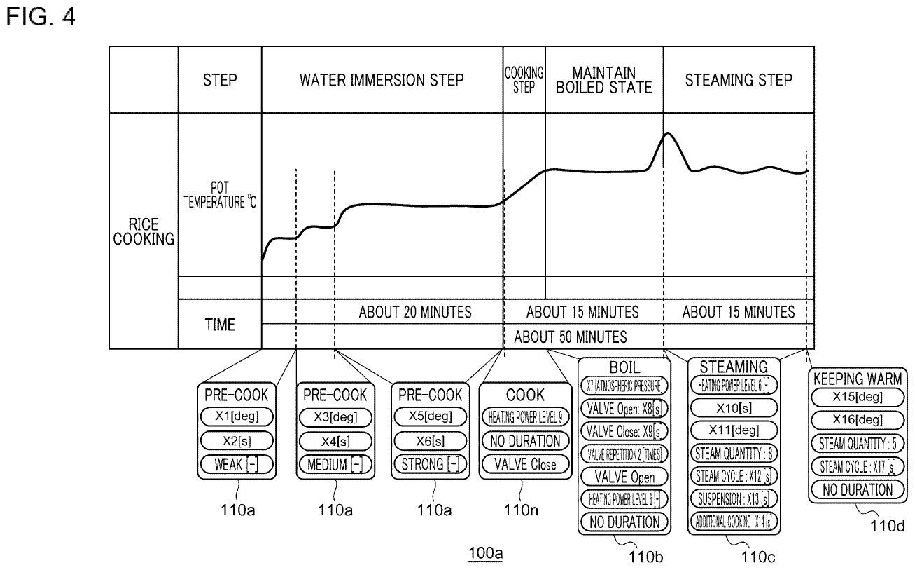

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

### (2) Evaluation Formula and Image Representation of Functional Block Sequence

In the description given so far, the functional block 110 is defined in a functional unit that can be executed by the appliance 100, and the functional block sequence 120 in which one or more functional blocks 110 are arranged in the order of operation is defined. The functional block 110 does not include an operation to be executed by a person, and the functional block sequence 120 does not include information other than the functional block 110 such as information on an ingredient, etc. On the other hand, they may be required for the process actually intended. To address this, the functional block 110 and the functional block sequence 120 described so far are expanded in the following. Therefore, the functional block 110 is also defined in a unit of operation to be executed by a person, and information such as an ingredient is also arranged in the functional block sequence 120. By expressing an operation of a person as the functional block 110, it can be dealt with in the same way as the operation of the appliance 100. If an operation of a person that cannot be replaced by the appliance 100 at the present time can be replaced by the appliance 100 in the future, therefore, the same functional block sequence 120 can be used to execute cooking, etc.

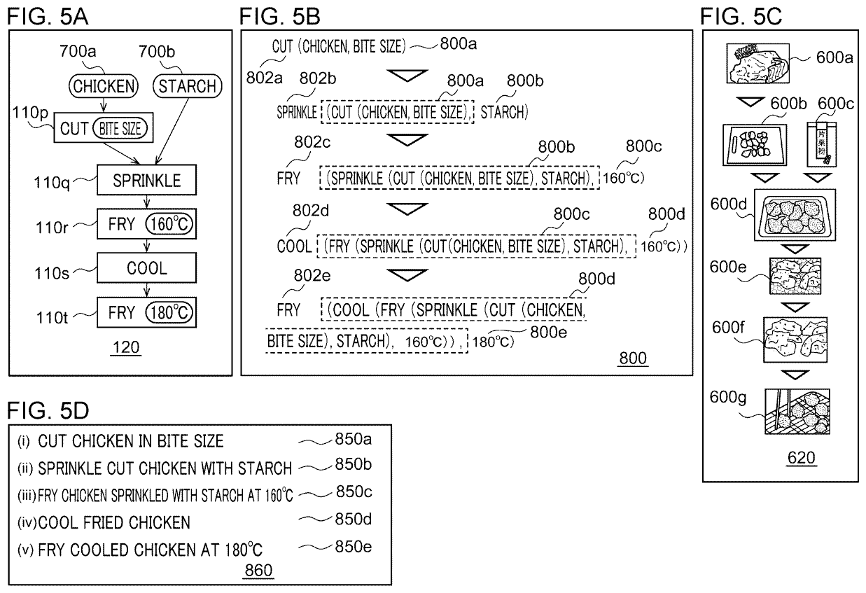

FIGS. 5A-5D show various representations of the functional block sequence 120 in the appliance control system 1000. FIG. 5A shows the functional block sequence 120 for cooking “karaage”. As shown, a functional block 110p of “cut” is arranged to follow an ingredient 700a “chicken”, and the functional block 110p of “cut” and the ingredient 700b “starch” are input to a functional block 110q of “sprinkle”. Thus, the functional block 110 may receive a plurality of inputs (the output of the functional block 110p and the ingredient 700b). Further, a functional block 110q of “sprinkle”, a functional block 110r of “fry”, a functional block 110s of “cool”, and a functional block 110t of “fry” are arranged in order. In that process, a parameter “bite size” is set in the functional block 110p of “cut”, a parameter “160°” is set in the functional block 110r of “fry”, and a parameter “180°” is set in the functional block 110t of “fry”.

In the order in which the functional blocks 110 are arranged in the functional block sequence 120, the first step, the second step, . . . are defined. In the functional block sequence 120 of FIG. 5A, the functional block 110p of “cut” corresponds to the “first step”, the functional block 110q of “sprinkle” corresponds to the “second step”, the functional block 110r of “fry” corresponds to the “third step”, the functional block 110s of “cool” corresponds to the “fourth step”, and the functional block 110t of “fry” corresponds to the “fifth step”.

The functional block 110r of “fry” and the functional block 110t of “fry” are functional blocks 110 defined in a functional unit that the appliance 100 can execute. Further, the functional block 110p of “cut”, the functional block 110q of “sprinkle”, and the functional block 110s of “cool” are functional blocks 110 defined in a unit of operation to be executed by a person. When the functional block 110 defined in a functional unit that the appliance 100 can execute is referred to as “the first type functional block 110”, the functional block 110 defined in a unit of operation to be executed by a person is referred to as “the second type functional block 110”. To distinguish between the first type functional block 110 and the second type functional block 110, a flat is set in the functional block 110. The ingredient 700a “chicken” and the ingredient 700b “starch” are information on the ingredient.

As described above, the functional block sequence 120 can be created by arranging one or more functional blocks 110, and the functional block sequence 120 can be updated by changing the functional block 110 included in the functional block sequence 120. By using the functional block sequence 120 like this, various recipes can be represented. If the understanding of the relationship between the function/operation of the appliance 100 and the functional block 110 is insufficient, however, the user may have questions such as what kind of functional block 110 should be used, what parameter should be set in the functional block 110, etc. For example, it is difficult for a recipe user to imagine what kind of dish can be made from the functional block sequence 120. Also, for example, it is difficult for a recipe author to imagine which functional blocks should be arranged and in what order they should be arranged to create a desired recipe. For such users, an image or a text is easier to understand than the functional block sequence 120.

To enable conversion between the functional block sequence 120 and an image or a text, an evaluation formula that can be converted to the functional block sequence 120, an image, and a text, respectively, is introduced in this embodiment. The evaluation formula is a formula representing a procedure for causing the appliance 100 or a person to execute the intended process. The evaluation formula is configured such that one or more functions are in a nested structure. One function corresponds to one functional block. By including an ingredient as an input to the function, the ingredient can also be dealt with as a parameter of the functional block 110.

FIG. 5B shows an evaluation formula 800 introduced in this embodiment. The figure shows the evaluation formula 800 for creating “karaage” like the functional block sequence 120 of FIG. 5A. The evaluation formula 800 includes functions 802. Like the functional block 110, the function 802 represents a step (function, operation) executed by the appliance 100. A function 802a “cut”, a function 802b “sprinkle”, a function 802c “fry”, a function 802d “cool”, and a function 802e “fry” correspond to the functional block 110p of “cut”, the functional block 110q of “sprinkle”, the functional block 110r of “fry”, the functional block 110s of “cool”, and the functional block 110t of “fry” of FIG. 5A.

Further, the evaluation formula 800 has a nested structure to represent the procedure in the functional block sequence 120. An evaluation formula 800a of the first step includes the function 802a “cut”. An evaluation formula 800b of the second step includes the function 802b “sprinkle”, and the argument of the function 802b “sprinkle” includes the evaluation formula 800a of the first step. This indicates that the result of the evaluation formula 800a of the first step is input to the evaluation formula 800b of the second step and shows the relationship between the evaluation formulas 800 clearly. The same applies to an evaluation formula 800c of the third step, an evaluation formula 800d of the fourth step, and an evaluation formula 800e of the fifth step. That is, one or more functions 802 are arranged in the evaluation formula 800.

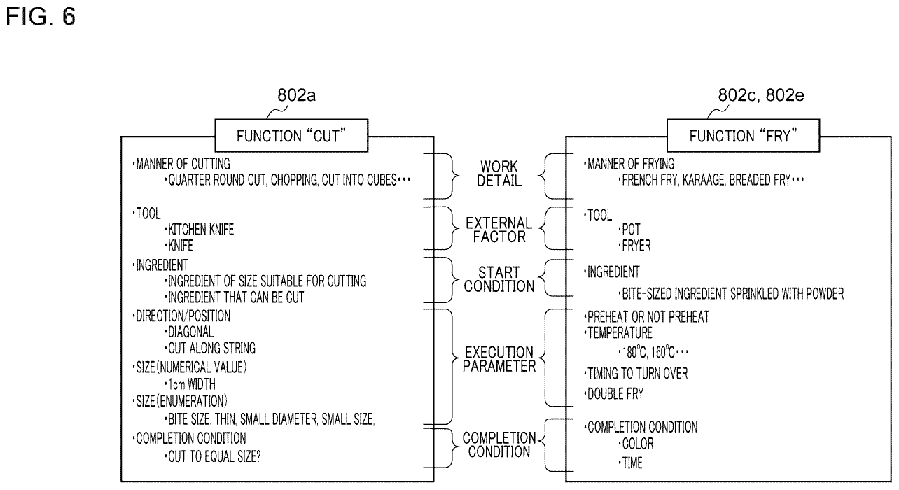

In this example, FIG. 6 is used to show arguments of the function 802. FIG. 6 shows a specific example of the function 802. On the left side is shown the function 802a “cut”, and on the right side are shown the function 802c “fry” and the function 802e “fry”. In the argument of these functions 802, the work detail, external factor, start condition, execution parameter, and completion condition are set as input variables.

In the case of the function 802a “cut”, the work detail indicates the manner of cutting such as quarter round cut and chopping, and the external factor indicates a tool such as a kitchen knife and a knife. Further, the start condition indicates an ingredient, and the execution parameter indicates the direction/position, size (numerical value), and size (enumeration). By way of example, an ingredient “chicken” and a size (enumeration) “bite size” are set in the function 802a “cut” in the evaluation formula 800a of the first step of FIG. 5B.

In the case of the function 802e “fry”, the work detail indicates a frying method such as French fry and karaage, and the external factor indicates a tool such as a pot and a fryer. Further, the start condition indicates an ingredient, and the execution parameter indicates preheat or not preheat, temperature, timing to turn over, and double fry. By way of example, in the function 802c “fry” in the evaluation formula 800c of the third step of FIG. 5B, the ingredient “the evaluation formula 800b of the second step” and the temperature “160°” are set. In this case, the ingredient “the evaluation formula 800b of the second step” indicates the result of the evaluation formula 800b of the second step, i.e., “chicken cut into bite size and sprinkled with starch”.

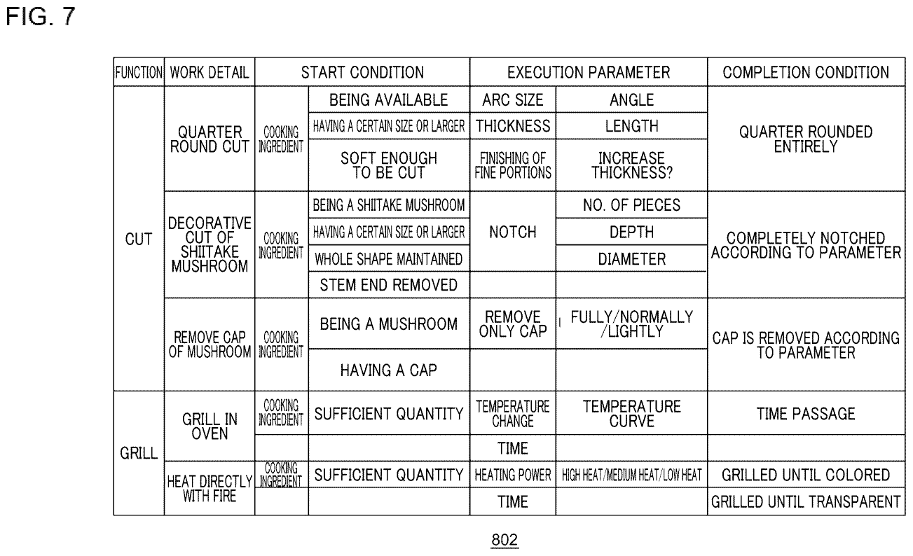

FIG. 7 shows another specific example of function 802. The figure shows a further example of the work detail, start condition, execution parameter, and completion condition in the function 802a “cut”. The figure also shows the work detail, etc. of the function 802 “grill”. It should be noted that the start condition may include not only an ingredient but also a tool indicated as an external factor.

FIG. 5C shows a sequence image 620 converted from the evaluation formula 800 of FIG. 5B. The sequence image 620 is comprised of a plurality of images 600 arranged in the order of operation to cause the appliance 100 or a person to execute the intended process. An image 600a “chunk of chicken” and an image 600c “starch” correspond to the argument of the function 802a “cut” and the argument of the function 802b “sprinkle” of FIG. 5B, respectively. Further, an image 600b “chicken cut into bite size”, an image 600d “bite-sized chicken thinly sprinkled with starch”, an image 600e “chicken fried at 160°”, an image 600f “cooled chicken”, an image 600g “chicken fried at 180°” correspond to the result of the function 802a “cut”, the result of the function 802b “sprinkle”, the result of the function 802c “fry”, the result of the function 802d “cool”, and the result of the function “fry” in FIG. 5B, respectively. Each image 600 represents a result of a step but may represent a state in which the step can be executed, i.e., a state in which the step is started or may represent a progress of the step.

FIG. 5D shows a sequence text 860 converted from the evaluation formula 800 of FIG. 5B. The sequence text 860 is comprised of a plurality of texts 850 arranged in the order of operation to cause the appliance 100 or a person to execute the intended process. A text 850a “cut the chicken into bite size”, a text 850b “sprinkle the cut chicken with starch”, a text 850c “fry the chicken sprinkled with starch at 160° C.”, a text 850d “cool the fried chicken”, a text 850e “fry the cooled chicken at 180°” correspond to the detail of the step of the function 802a “cut”, the detail of the step of the function 802b “sprinkle”, the detail of the function 802c “fry”, the detail of the step of the function 802d “cool”, and the detail of the step of the function 802e “fry” in FIG. 5B, respectively. The text 850 represents the detail of the step.

As shown in FIGS. 5A-5D, the functional block sequence 120, the evaluation formula 800, the sequence image 620, and the sequence text 860 correspond to each other. Therefore, the correspondence between the function 802 and the functional block 110 (hereinafter referred to as the “first correspondence”), the correspondence between the function 802 and the image 600 (hereinafter referred to as the “second correspondence”), and the correspondence between the function 802 and the text 850 (hereinafter referred to as the “third correspondence”) are defined so that conversion between the functional block sequence 120, the sequence image 620, and the sequence text 860 is possible by way of the evaluation formula 800.

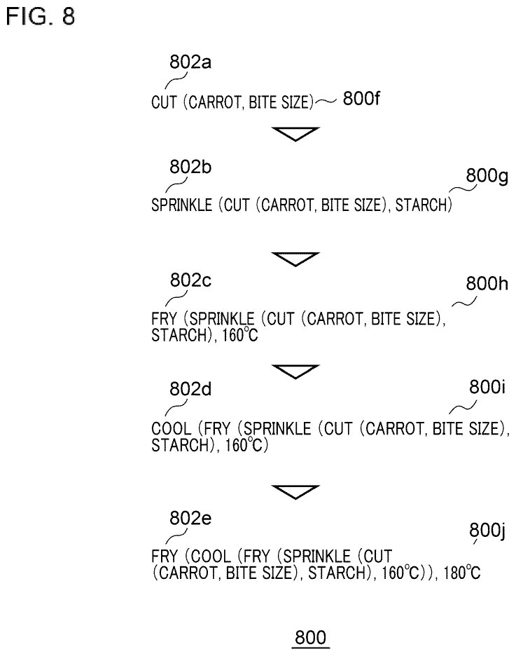

FIG. 8 shows the evaluation formula 800 derived from changing a part of the evaluation formula 800 of FIG. 5B. An evaluation formula 800f of the first step includes the “cut” function 802a like the evaluation formula 800a of the first step in FIG. 5B. However, the argument of the “cut” function 802a is changed from “chicken” to “carrot”. Further, an evaluation formulas 800g of the second step to an evaluation formula 800j of the fifth step correspond to the evaluation formula 800b of the second step to the evaluation formula 800d of the fifth step in FIG. 5B, respectively, except that “chicken” is changed to “carrot” as described above. By changing the argument of the function 802 in this way, it is possible to update the evaluation formula 800. The update to the evaluation formula 800 is also reflected in the functional block sequence 120, the sequence image 620, and the sequence text 860 converted from the evaluation formula 800.

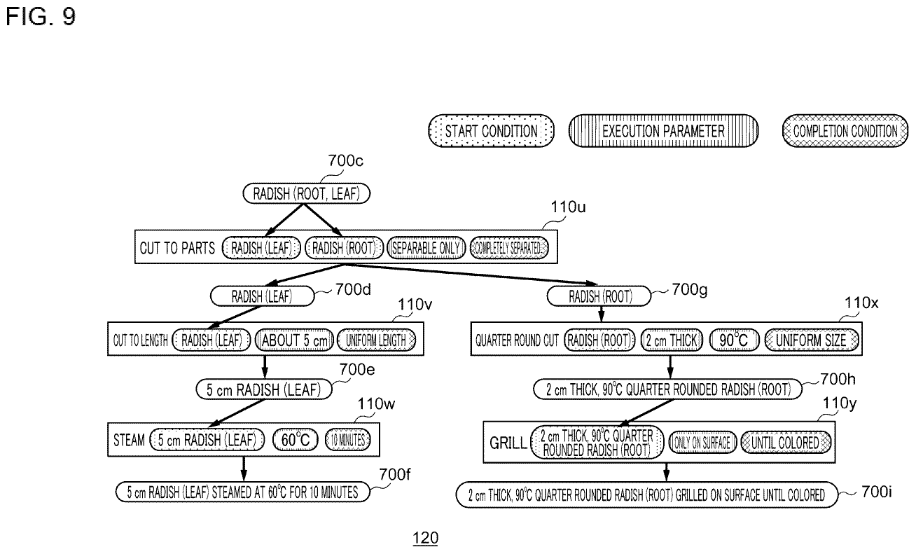

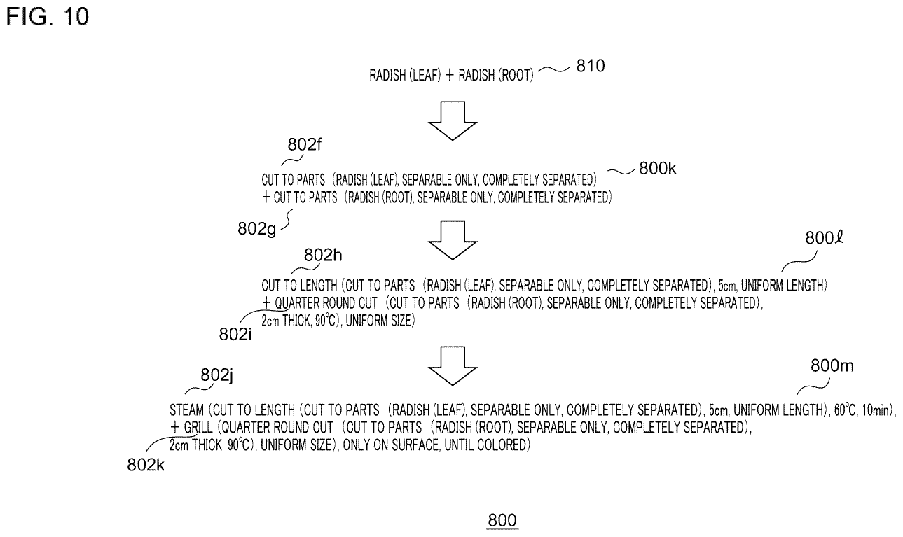

FIGS. 9 and 10 show an exemplary process directed to a purpose other than that of FIGS. 5A-5B. FIG. 9 shows a specific example of the functional block sequence 120 in the appliance control system 1000, and FIG. 10 shows the evaluation formula 800 for the functional block sequence 120 of FIG. 9. In the functional block sequence 120 of FIG. 9, an ingredient 700c “radish (leaf, root)” is input to a functional block 110u of “carve”. The functional block 110u of “carve” outputs an ingredient 700d “radish (leaf)” and an ingredient 700g “radish (root)”. The ingredient 700d “radish (leaf)” is input to a functional block 110v of “cut to a length”, and the functional block 110v of “cut to a length” outputs an ingredient 700e “5 cm radish (leaf)”. The ingredient 700e “5 cm radish (leaf)” is input to a functional block 110w of “steam”, and the functional block 110w of “steam” outputs an ingredient 700f “5 cm radish (leaf) steamed at 60° C. for 10 minutes”.

The ingredient 700g “radish (root)” is input to a functional block 110x of “quarter round cut”, and the functional block 110x of “quarter round cut” outputs an ingredient 700h “2 cm thick, 90° quarter rounded radish (root)”. The ingredient 700h “2 cm thick, 90° quarter rounded radish (root)” is input to a functional block 110y of “grill”, and the functional block 110y of “grill” outputs an ingredient 700i “2 cm thick, 90° quarter rounded radish (root) grilled until the surface is colored”.

In the evaluation formula 800 of FIG. 10, an ingredient 810, an evaluation formula 800k of the first step, an evaluation formula 800l of the second step, and an evaluation formula 800m of the third step are arranged in order. The evaluation formula 800k of the first step includes a function 802f “carve” and a function 802g “carve”, and the evaluation formula 800l of the second step includes a function 802h “cut to a length” and a function 802i “quarter round cut”, and the evaluation formula 800m of the third step includes a function 802j “steam” and a function 802k “grill”. The function 802f “carve” and the function 802g “carve” correspond to the functional block 110u of “carve” in FIG. 9. Further, the function 802h “cut to a length”, the function 802i “quarter round cut”, the function 802j “steam”, and the function 802k “grill” correspond to the “cut to a length” functional block 110v, the “quarter round cut” functional block 110x, the “steam” functional block 110w, and the “grill” functional block 110y in FIG. 9, respectively. In the case of FIGS. 9 and 10, too, conversion between the functional block sequence 120 and the evaluation formula 800 is possible. The evaluation formula 800 can also be converted into or from the sequence image 620 (not shown) or the sequence text 860 (not shown).

### (3) Configuration of Appliance Control System

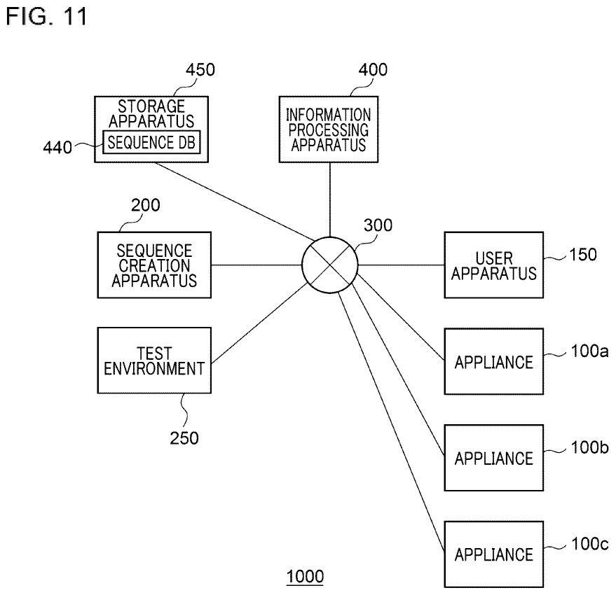

FIG. 11 shows a configuration of the appliance control system 1000. The appliance control system 1000 includes an appliance 100a to an appliance 100c, a user apparatus 150, a sequence creation apparatus 200, a test environment 250, a network 300, an information processing apparatus 400, and a storage apparatus 450. Further, the storage apparatus 450 includes a sequence DB 440.

The appliances 100a to 100c are, for example, the rice cooker, washing machine, and microwave oven of FIG. 1A. Each appliance 100 executes the processes in the first and second layers of FIG. 1A and are also connected to the network 300. In addition to the appliance 100, the user apparatus 150, the sequence creation apparatus 200, the test environment 250, the information processing apparatus 400, and the storage apparatus 450 are also connected to the network 300. In the network 300, either wired communication, wireless communication, or a combination of wired communication and wireless communication is executed between these apparatuses.

The sequence creation apparatus 200 is an apparatus used by a user (hereinafter sometimes referred to as “creator”) who creates the functional block sequence 120 and is, for example, a computer, a smartphone, or a tablet terminal.

The information processing apparatus 400 creates or updates the functional block sequence 120 in cooperation with the sequence creation apparatus 200. Further, the information processing apparatus 400 executes conversion between the evaluation formula 800, the functional block sequence 120, the sequence image 620, and the sequence text 860. The information processing apparatus 400 is, for example, a computer such as a server, a cloud server, etc. provided with a processor, a memory, etc. The information processing apparatus 400 is also the user application server 132 for executing the process in the fourth layer of FIG. 1A.

The storage apparatus 450 is, for example, an HDD (Hard Disk Drive) or an SSD (Solid State Drive) and can store electronic information. The sequence DB 440 stores the functional block sequence 120 created or generated in the information processing apparatus 400.

The test environment 250 is an apparatus for causing the functional block sequence 120 created by the creator to operate. The test environment 250 receives the functional block sequence 120 from the information processing apparatus 400 and executes the operation according to the functional block sequence 120. The test environment 250 is used to confirm that the functional block sequence 120 created by the creator does not have a defect.

The user apparatus 150 is an apparatus used by a user who executes the intended process such as cooking and is, for example, a computer, a smartphone, or a tablet terminal. The user apparatus 150 receives the sequence image 620 or the sequence text 860 for the intended process from the information processing apparatus 400 and displays the sequence image 620 or the sequence text 860 received. The user executes the intended process by checking the sequence image 620 or the sequence text 860 displayed in the user apparatus 150.

Further, the information processing apparatus 400 transmits to the appliance 100 a portion (hereinafter also referred to as the “functional block sequence 120”) of the functional block sequence 120 for the intended process that is executed by the appliance 100. The appliance 100 executes process according to the functional block sequence 120 received.

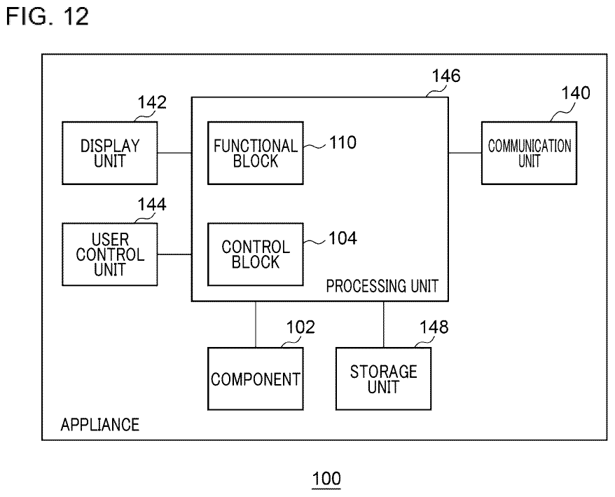

FIG. 12 shows a configuration of the appliance 100. The appliance 100 includes a component 102, a communication unit 140, a display unit 142, a user control unit 144, a processing unit 146, and a storage unit 148. The processing unit 146 includes a functional block 110 and a driver 104. As described above, the appliance 100 is a household electrical/mechanical appliance such as a rice cooker, washing machine, and microwave oven. A plurality of components 102, drivers 104, and functional blocks 110 are provided as shown in FIGS. 1B-1G, but only one is shown here for clarity of the drawing.

The communication unit 140 is connected to the network 300 and communicates with the information processing apparatus 400 via the network 300. For example, the communication unit 140 receives information on the functional block sequence 120 from the information processing apparatus 400. The functional block sequence 120 includes the functional block 110 of the functional block sequence 120 for the intended process that is to be executed by the appliance 100. Further, the storage unit 148 stores the functional block 110 that can be executed in the appliance 100. Based on the information on the functional block sequence 120 received by the communication unit 140, the processing unit 146 reads the functional block 110 stored in the storage unit 148 and causes the component 102 to execute the process according to the functional block sequence 120 via the driver 104.

The display unit 142 displays the information from the processing unit 146. The user control unit 144 is an interface capable of receiving an input from the user and is, for example, a button. Alternatively, the display unit 142 and the user control unit 144 may be integrated as a touch panel. The user control unit 144 outputs the received input to the processing unit 146.

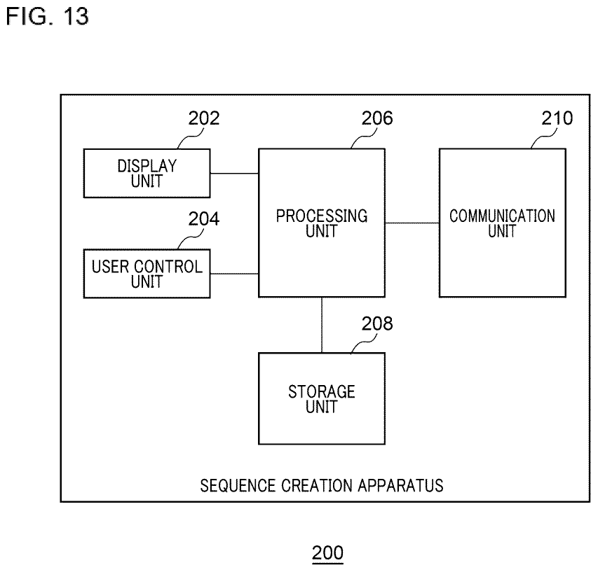

FIG. 13 shows a configuration of the sequence creation apparatus 200. The sequence creation apparatus 200 includes a display unit 202, a user control unit 204, a processing unit 206, a storage unit 208, and a communication unit 210. As described above, the sequence creation apparatus 200 is a computer, a smartphone, or a tablet terminal. The display unit 202 displays information received from the processing unit 206. The user control unit 204 is an interface capable of receiving an input from the creator and is, for example, a button. Alternatively, the display unit 202 and the user control unit 204 may be integrated as a touch panel. The user control unit 204 outputs the received input to the processing unit 206.

The processing unit 206 outputs information that should be displayed to the display unit 202 and receives an input from the user control unit 204. Further, the processing unit 206 causes the storage unit 208 to store information or reads information from the storage unit 208. Further, the processing unit 206 connects to the network 300 via the communication unit 210 and communicates with the information processing apparatus 400 via the network 300. In such a configuration, the processing unit 206 executes a process to create or update the functional block sequence 120 based on an input from the creator while communicating with the information processing apparatus 400.

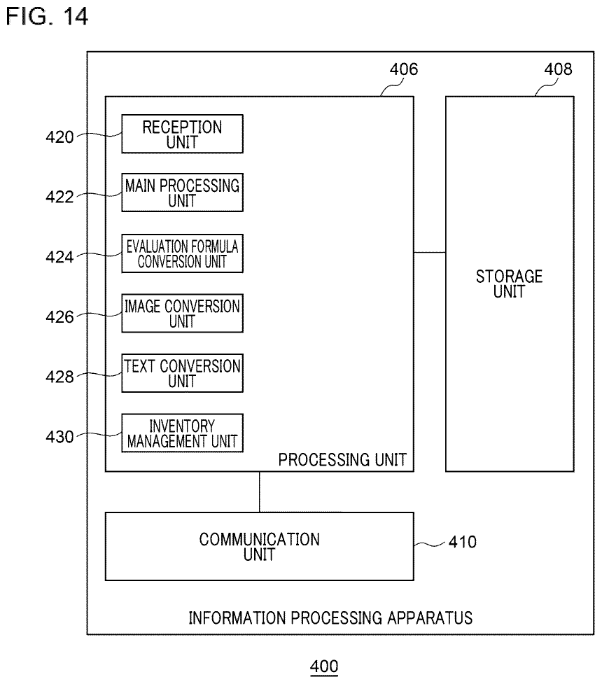

FIG. 14 shows a configuration of the information processing apparatus 400. The information processing apparatus 400 includes a processing unit 406, a storage unit 408, and a communication unit 410. The processing unit 406 includes a reception unit 420, a main processing unit 422, an evaluation formula conversion unit 424, an image conversion unit 426, a text conversion unit 428, and an inventory management unit 430.

The processing unit 406 executes a process in the information processing apparatus 400. For example, the processing unit 406 creates or updates the functional block sequence 120 and executes conversion between the evaluation formula 800, the functional block sequence 120, the sequence image 620, and the sequence text 860. Details of the process in the processing unit 406 will be described later. The storage unit 408 stores information used in the processing unit 406. The communication unit 410 is connected to the network 300 and communicates with the appliance 100, the user apparatus 150, the sequence creation apparatus 200, the test environment 250, and the storage apparatus 450 via the network 300.

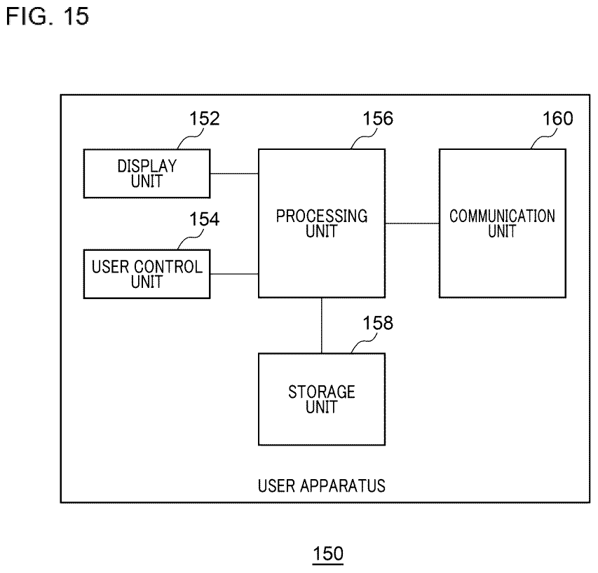

FIG. 15 shows a configuration of the user apparatus 150. The user apparatus 150 includes a display unit 152, a user control unit 154, a processing unit 156, a storage unit 158, and a communication unit 160. As described above, the user apparatus 150 is a computer, a smartphone, or a tablet terminal. The display unit 152 displays information received from the processing unit 156. The user control unit 154 is an interface capable of receiving an input from the user and is, for example, a button. Alternatively, the display unit 152 and the user control unit 154 may be integrated as a touch panel. The user control unit 154 outputs the received input to the processing unit 156.

The processing unit 156 outputs information that should be displayed to the display unit 152 and receives an input from the user control unit 154. Further, the processing unit 156 causes the storage unit 158 to store information and reads information from the storage unit 158. Further, the processing unit 156 connects to the network 300 via the communication unit 160 and executes communication with the information processing apparatus 400 via the network 300.

When the user control unit 154 in this configuration receives an instruction to execute the intended process, the processing unit 156 causes the instruction for execution to be transmitted from the communication unit 160 to the information processing apparatus 400. Further, when the communication unit 160 receives information on a screen (hereinafter referred to as “sequence display IF”) for displaying the sequence image 620 or the sequence text 860 from the information processing apparatus 400, the processing unit 156 causes the display unit 152 to display the sequence display IF.

### (4) Creation of Functional Block Sequence

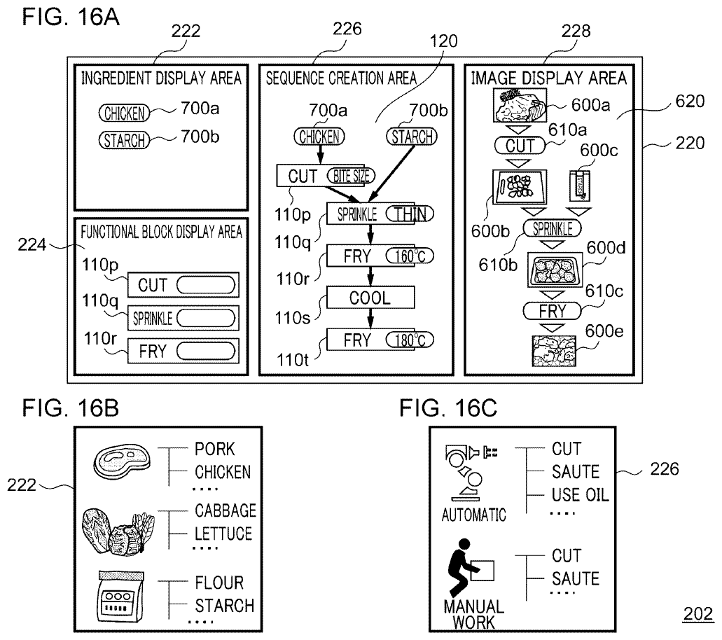

As described above, the functional block sequence 120 is created in the information processing apparatus 400 in response to the creator's user control in the sequence creation apparatus 200 by way of communication between the sequence creation apparatus 200 and the information processing apparatus 400. The processing unit 206 of the sequence creation apparatus 200 causes the display unit 202 to display a screen (hereinafter referred to as “sequence creation IF”) for creating the functional block sequence 120. FIGS. 16A-16(c) show a sequence creation IF 220 displayed on the display unit 202. In the sequence creation IF 220 of FIG. 16A, an ingredient display area 222, a functional block display area 224, a sequence creation area 226, and an image display area 228 are arranged.

In the ingredient display area 222, the ingredient 700a “chicken” and the ingredient 700b “starch” are arranged. Other ingredients 700 may be arranged in the ingredient display area 222. The ingredient display area 222 may be shown as in FIG. 16B. In this case, the ingredients 700 are grouped and displayed according to type. For example, pork and chicken, which are meats, are displayed together, and cabbage and lettuce, which are vegetables, are displayed together.

The functional block 110p of “cut”, the functional block 110q of “sprinkle”, and the functional block 110r of “fry” are arranged in the functional block display area 224. Other functional blocks 110 may be arranged in the functional block display area 224. The functional block 110 may be shown as in FIG. 16C. In this case, the functional block 110 related to automatic operation and the functional block 110 related to manual operation are displayed separately. The functional block 110 related to automatic operation corresponds to the first type functional block 110, and the functional block 110 related to manual operation corresponds to the second type functional block 110.

The sequence creation area 226 is an area for creating the functional block sequence 120 using the ingredient 700 and the functional block 110. The creator uses the user control unit 204 to move the ingredient 700 in the ingredient display area 222 to the sequence creation area 226 and moves the functional block 110 in the functional block display area 224 to the sequence creation area 226. Further, the creator uses the user control unit 204 to arrange the functional block 110 and the ingredient 700 in the order of operation in the sequence creation area 226. In that process, parameters are input to the functional block 110. The processing unit 206 of the sequence creation apparatus 200 of FIG. 15 the communication unit 210 to transmit, as input information, information on the functional block 110 and the ingredient 700 arranged in the sequence creation area 226 to the information processing apparatus 400.

The communication unit 410 of the information processing apparatus 400 of FIG. 14 receives the input information from the sequence creation apparatus 200. The reception unit 420 receives the information on the functional block 110 and the ingredient 700 included in the input information. The main processing unit 422 outputs an update request including the information of the functional block 110 and the ingredient 700 received to the sequence DB 440, thereby storing the functional block 110 and the ingredient 700 in the sequence DB 440 as the functional block sequence 120. The main processing unit 422 receives the functional block sequence 120 thus stored from the sequence DB 440.

The main processing unit 422 requests the evaluation formula conversion unit 424 to convert the functional block sequence 120 into the evaluation formula 800 by outputting the functional block sequence 120 to the evaluation formula conversion unit 424. The evaluation formula conversion unit 424 converts the functional block sequence 120 into the evaluation formula 800 by converting each functional block 110 included in the functional block sequence 120 into the function 802, based on the above-described first correspondence maintained in advance. The evaluation formula conversion unit 424 outputs the evaluation formula 800 to the main processing unit 422.

The main processing unit 422 receives the evaluation formula 800 from the evaluation formula conversion unit 424. This is equivalent to acquiring the evaluation formula 800 in which one or a plurality of functions 802 representing a step executed by the appliance 100 or a person and receiving a start condition, execution parameter, and completion condition as input variables are arranged. The main processing unit 422 requests the image conversion unit 426 to convert the evaluation formula 800 into the sequence image 620 by outputting the evaluation formula 800 to the image conversion unit 426. The image conversion unit 426 converts the evaluation formula 800 into the sequence image 620 by converting each function 802 included in the evaluation formula 800 into the image 600, based on the second correspondence maintained in advance. The image conversion unit 426 may not use the second correspondence, may acquire the image 600 suited to each function 802 included in the received evaluation formula 800 by Internet search, and may generate the sequence image 620 from the acquired image 600. The image conversion unit 426 outputs the sequence image 620 to the main processing unit 422. The main processing unit 422 causes a display instruction for displaying the sequence image 620 to be transmitted from the communication unit 410 to the sequence creation apparatus 200. Sending a display instruction is equivalent to displaying information related to the step in a step by step manner, based on one or more functions 802 included in the evaluation formula 800 acquired.

The communication unit 210 of the sequence creation apparatus 200 receives the display instruction from the information processing apparatus 400. Based on the display instruction, the processing unit 206 updates the sequence creation IF 220 so that the sequence image 620 is arranged in the image display area 228 of FIG. 16. The processing unit 206 displays the updated sequence creation IF 220 on the display unit 202. The sequence image 620 is arranged in the image display area 228 of FIG. 16. In this example, the image 600 following the image 600e “chicken fried at 160° C.” is omitted. Alternatively, an auxiliary image 610 representing the detail of the step of the function 802 may be arranged in the image display area 228. For example, the function 802a “cut”, the function 802b “sprinkle”, and the function 802c “fry” are arranged.

The creator can use the user control unit 204 of the sequence creation apparatus 200 while looking at the sequence image 620 arranged in the image display area 228 to change at least one of the functional blocks 110 and the ingredient 700 shown in the sequence creation area 226. When the processing unit 206 receives the detail of change from the user control unit 204, the processing unit 206 causes input information including the detail of change to be transmitted from the communication unit 210 to the information processing apparatus 400.

The communication unit 410 of the information processing apparatus 400 of FIG. 14 receives the input information from the sequence creation apparatus 200. The reception unit 420 acquires the detail of change included in the input information. The main processing unit 422 updates the functional block sequence 120 stored in the sequence DB 440 by outputting an update request including the detail change received, i.e., the differential of the functional block sequence 120, to the sequence DB 440. The main processing unit 422 receives the updated functional block sequence 120 from the sequence DB 440. The subsequent process is the same as described before.

As a result, the sequence image 620 arranged in the image display area 228 of the sequence creation apparatus 200 is sequentially updated according to a change in the functional block sequence 120. Thus, the functional block sequence 120 is converted into the sequence image 620 and displayed so that the function/operation of the appliance 100 is displayed in an easy-to-understand manner. As a result, the creator can easily understand the detail of the functional block sequence 120 by checking the sequence image 620.

The main processing unit 422 may include the functional block sequence 120 in the display instruction. In that process, the user apparatus 150 updates the display in the sequence creation area 226 in the sequence creation IF 220 by the functional block sequence 120 included in the display instruction.

The features are implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

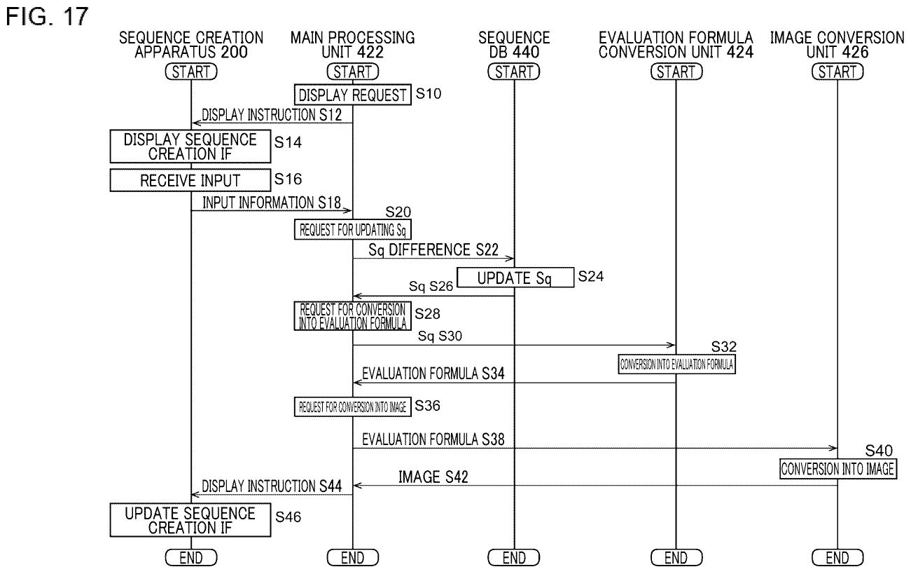

FIG. 17 is a sequence chart showing a display procedure executed by the appliance control system 1000. The main processing unit 422 receives a request for displaying the sequence creation IF 220 from the sequence creation apparatus 200 (S10). The main processing unit 422 transmits the request for displaying the sequence creation IF 220 to the sequence creation apparatus 200 (S12). The sequence creation apparatus 200 displays the sequence creation IF 220 (S14). The sequence creation apparatus 200 receives an input from the creator (S16). It will be assumed that the input in this example is an update to the functional block sequence 120. The sequence creation apparatus 200 transmits the input information to the main processing unit 422 (S18). The main processing unit 422 generates a request for updating the functional block sequence 120 (Sq) (S20) and transmits a Sq differential to the sequence DB 440 (S22). The sequence DB 440 updates Sq (S24) and transmits Sq to the main processing unit 422 (S26).

The main processing unit 422 generates a request for conversion into the evaluation formula 800 (S28) and outputs Sq to the evaluation formula conversion unit 424 (S30). The evaluation formula conversion unit 424 executes conversion into the evaluation formula 800 (S32) and outputs the evaluation formula 800 to the main processing unit 422 (S34). The main processing unit 422 generates a request for conversion into the sequence image 620 (S36) and outputs the evaluation formula 800 to the image conversion unit 426 (S38). The image conversion unit 426 executes conversion into the sequence image 620 (S40) and outputs the sequence image 620 to the main processing unit 422 (S42). The main processing unit 422 transmits a display instruction to the sequence creation apparatus 200 (S44). The sequence creation apparatus 200 updates and displays the sequence creation IF 220 (S46).

### (5) Update to Functional Block Sequence

It is assumed in this example that a user using the functional block sequence 120 already created updates the functional block sequence 120 according to the usage environment at home by using the user apparatus 150. The sequence DB 440 in the storage apparatus 450 of FIG. 11 stores the functional block sequence 120 already created. In response to a request from the user apparatus 150, the main processing unit 422 of the information processing apparatus 400 acquires the functional block sequence 120 from the sequence DB 440. By executing the same process as described above, the main processing unit 422 receives the evaluation formula 800 corresponding to the functional block sequence 120 from the evaluation formula conversion unit 424 and receives the sequence image 620 corresponding to the evaluation formula 800 from the image conversion unit 426.

The main processing unit 422 requests the text conversion unit 428 to convert the evaluation formula 800 into the sequence text 860 by outputting the evaluation formula 800 to the text conversion unit 428. The text conversion unit 428 converts the evaluation formula 800 into the sequence text 860 by converting each function 802 included in the evaluation formula 800 into the text 850 based on the third correspondence maintained in advance. In this process, the text conversion unit 428 may not use the third correspondence and may cause an external server to execute conversion into the text 850 suited to each function 802 included in the received evaluation formula 800 via the Internet, thereby generating the sequence text 860 from the text 850 resulting from the conversion. The text conversion unit 428 outputs the sequence text 860 to the main processing unit 422.

The inventory management unit 430 communicates with the appliance 100 owned by the user (e.g., a refrigerator) via the network 300. For example, the refrigerator is provided with a sensor (imaging apparatus) capable of capturing an image inside, and the ingredient stored in the refrigerator is imaged by the sensor. The refrigerator transmits the image thus captured (hereinafter referred to as “captured image”) to the information processing apparatus 400 via the network 300. The inventory management unit 430 recognizes the ingredient 700 stored in the refrigerator by performing an image recognition process on the captured image. Inventory information may be entered by the user via the user apparatus 150. The inventory management unit 430 acquires the image 600 corresponding to the ingredient 700 recognized. The image 600 may be maintained in the inventory management unit 430 or may be retrieved via the Internet. Alternatively, an image generated by an image generation AI (Artificial Intelligence) may be used as the image 600. The inventory management unit 430 outputs the image 600 corresponding to the ingredient 700 to the main processing unit 422 as the inventory information. The main processing unit 422 causes the sequence image 620, the sequence text 860, and a display instruction for displaying the inventory information to be transmitted from the communication unit 410 to the user apparatus 150.

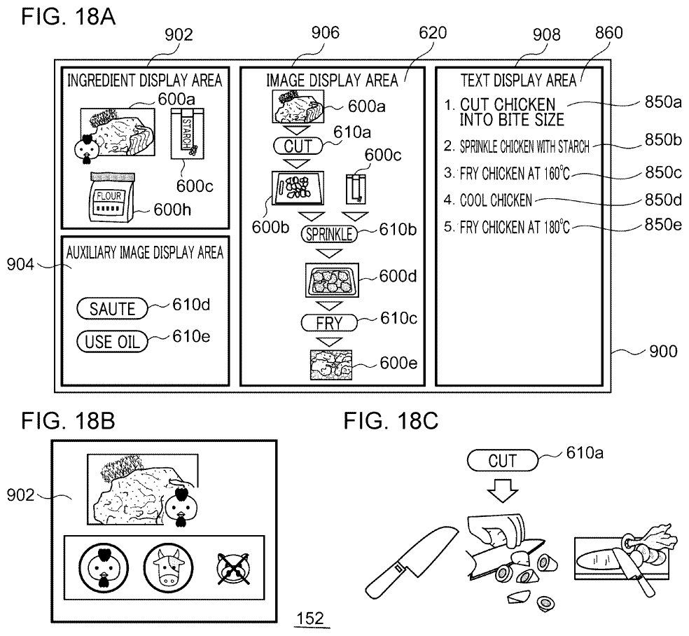

The communication unit 160 of the user apparatus 150 of FIG. 15 receives the display instruction from the information processing apparatus 400. The processing unit 156 generates a sequence display IF 900 and displays the sequence display IF 900 on the display unit 152 based on the display instruction. FIGS. 18A-18C show the sequence display IF 900 displayed on the display unit 152. In the sequence display IF 900 of FIG. 18A, an ingredient display area 902, an auxiliary image display area 904, an image display area 906, and a text display area 908 are arranged.

In the ingredient display area 902, the image 600a “chicken”, the image 600c “starch”, and an image 600h “flour” are arranged. When a plurality of types of ingredients 700 can be selected, the screen of FIG. 18B may be displayed when the image 600 in the ingredient display area 902 is selected. Ingredients 700 that are selectable (e.g., “chicken”, “beef”) and the ingredient 700 being selected (“chicken”) are shown. Further, when a plurality of types of ingredients 700 can be selected, the image 600 of the ingredient 700 selected based on a criterion such as “ingredient in the refrigerator”, “recently used ingredient”, “seasonal ingredient”, etc. may be displayed. When “ingredient in the refrigerator” is selected, the image 600 of the ingredient 700 included in the inventory information is displayed.

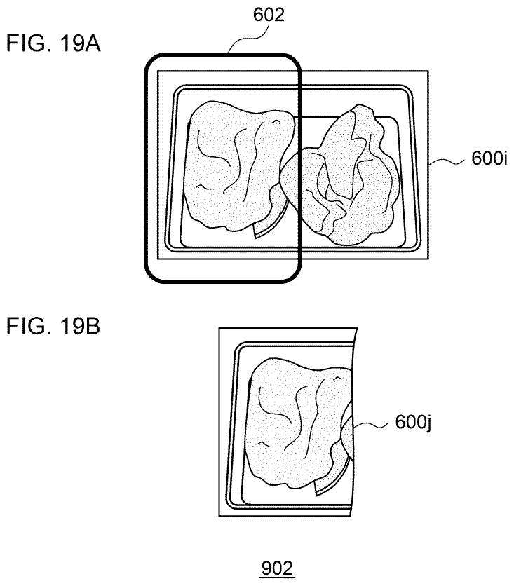

The image 600 of the ingredient 700 displayed in the ingredient display area 902 may reflect the quantity of the ingredient 700 used in the functional block sequence 120 and the quantity of the ingredient 700 included in the inventory information. This process is executed in the user apparatus 150 or the information processing apparatus 400. FIGS. 19A-19B show display in the ingredient display area 902. FIG. 19A shows display in the case where the quantity of the ingredient 700 “chicken” included in the inventory information is greater than the quantity of the ingredient 700 “chicken” used in the functional block sequence 120. For example, it is assumed that the quantity of the ingredient 700 “chicken” included in the inventory information is “500 g” and the quantity of the ingredient 700 “chicken” used in the functional block sequence 120 is “200 g”. In the ingredient display area 902, an image 600i “chicken” corresponding to the ingredient 700 “chicken” of “500 g” included in the inventory information is arranged. Further, a used portion 602 for indicating a portion corresponding to the ingredient 700 “chicken” of “200 g” used in the functional block sequence 120 is superimposed on the image 600i “chicken”.

FIG. 19B shows display in the case the quantity of the ingredient 700 “chicken” included in the inventory information and the quantity of the ingredient 700 “chicken” used in the functional block sequence 120 are the same. For example, it is assumed that the quantity of the ingredient 700 “chicken” included in the inventory information is also “200 g”. In the ingredient display area 902, an image 600j “chicken” corresponding to the ingredient 700 “chicken” of “200 g” included in the inventory information is arranged. Reference is made back to FIG. 18A.

In the auxiliary image display area 904, an auxiliary image 610d “saute” and an auxiliary image 610e “use oil” are arranged as the auxiliary image 610 that can be used. The auxiliary image 610 displayed in the auxiliary image display area 904 is not limited thereto. As described above, the auxiliary image 610 is an image showing the detail of the step of the function 802.

The sequence image 620 is arranged in the image display area 906. In this example, the image 600 following the image 600e “chicken fried at 160° C.” is omitted. Further, the auxiliary image 610 may be arranged in the image display area 228. The auxiliary image 610a “cut” may be shown as in, for example, FIG. 18C. The sequence text 860 is arranged in the text display area 908. The sequence text 860 includes a plurality of texts 850. The text 850 represents the detail of the step.

The user checks the sequence image 620 arranged in the image display area 906 or the sequence text 860 arranged in the text display area 908. When the user wants to update the sequence image 620, the user uses the user control unit 154 to change the arrangement of the image 600 or the auxiliary image 610 in the image display area 906. For example, the image 600h “flour” arranged in the ingredient display area 902 is replaced by the image 600c “starch” arranged in the image display area 906. Further, the user changes the parameter for the image 600 by using the user control unit 154 to select the image 600 in the image display area 906.

The processing unit 156 receives a change in the

arrangement of the image 600 or the auxiliary image 610 or a change in the parameter for the image 600 from the user control unit 154. The processing unit 156 causes the sequence image 620 (hereinafter referred to as the “updated sequence image 620”) in which the change is reflected to be transmitted from the communication unit 160 to the information processing apparatus 400 as updated information.

The communication unit 410 of the information processing apparatus 400 receives updated information from the user apparatus 150. The reception unit 420 acquires the updated sequence image 620 from the updated information. The main processing unit 422 outputs the updated sequence image 620 to the image conversion unit 426. The image conversion unit 426 converts the updated sequence image 620 into the evaluation formula 800 using the second correspondence. This evaluation formula 800 corresponds to the evaluation formula 800 that has been updated in accordance with the update to the sequence image 620. The image conversion unit 426 outputs the evaluation formula 800 to the main processing unit 422.

The main processing unit 422 outputs the received evaluation formula 800 to the evaluation formula conversion unit 424. The evaluation formula conversion unit 424 converts the evaluation formula 800 into the functional block sequence 120 using the first correspondence. This functional block sequence 120 corresponds to the functional block sequence 120 that has been updated in accordance with the update to the sequence image 620. The evaluation formula conversion unit 424 outputs the functional block sequence 120 to the main processing unit 422. The main processing unit 422 causes the functional block sequence 120 stored in the sequence DB 440 to be updated by outputting the received functional block sequence 120 to the sequence DB 440.

The main processing unit 422 outputs the received evaluation formula 800 to the text conversion unit 428. The text conversion unit 428 converts the evaluation formula 800 into the sequence text 860 using the third correspondence. This sequence text 860 corresponds to the sequence text 860 that has been updated in accordance with the update to the sequence image 620. The text conversion unit 428 outputs the sequence text 860 to the main processing unit 422. Further, the main processing unit 422 receives the inventory information from the inventory management unit 430. The main processing unit 422 causes the sequence image 620, the sequence text 860, and a display instruction for displaying the inventory information to be transmitted from the communication unit 410 to the user apparatus 150.

The communication unit 160 of the user apparatus 150 receives the display instruction from the information processing apparatus 400. The processing unit 156 generates the sequence display IF 900 and displays the sequence display IF 900 on the display unit 152 based on the display instruction. As a result, the change is reflected in the sequence display IF 900.

The main processing unit 422 may include the functional block sequence 120 in the display instruction. In that process, the user apparatus 150 displays the functional block sequence 120 on the display unit 152 by arranging the functional block sequence 120 in the sequence display IF 900.

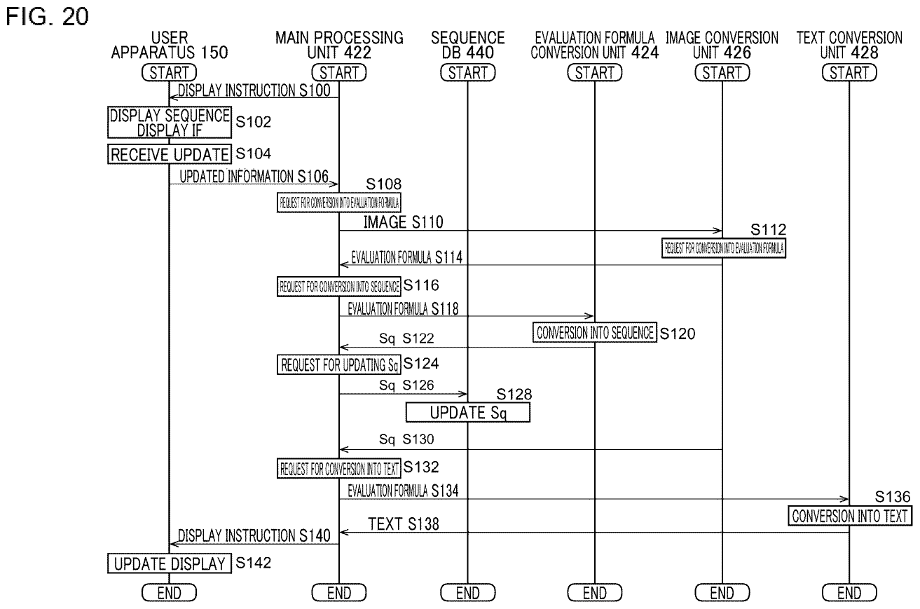

FIG. 20 is a sequence chart showing a display procedure executed by the appliance control system 1000. The main processing unit 422 transmits the instruction to display the sequence display IF 900 to the user apparatus 150 (S100). The user apparatus 150 displays the sequence display IF 900 (S102). The user apparatus 150 receives an update by the user (S104). The user apparatus 150 transmits the updated information to the main processing unit 422 (S106).

The main processing unit 422 generates a request for conversion into the evaluation formula 800 (S108) and outputs the sequence image 620 to the image conversion unit 426 (S110). The image conversion unit 426 executes conversion into the evaluation formula 800 (S112) and outputs the evaluation formula 800 to the main processing unit 422 (S114). The main processing unit 422 generates a request for conversion into the functional block sequence 120 (S116) and outputs the evaluation formula 800 to the evaluation formula conversion unit 424 (S118). The evaluation formula conversion unit 424 executes conversion into the functional block sequence 120 (S120) and outputs the functional block sequence 120 (Sq) to the main processing unit 422 (S122).

The main processing unit 422 generates a request for updating the functional block sequence 120 (S124) and transmits Sq to the sequence DB 440 (S126). The sequence DB 440 updates Sq (S128) and transmits Sq to the main processing unit 422 (S130). The main processing unit 422 generates a request for conversion into the sequence text 860 (S132) and outputs the evaluation formula 800 to the text conversion unit 428 (S134). The text conversion unit 428 executes conversion into the sequence text 860 (S136) and outputs the sequence text 860 to the main processing unit 422 (S138). The main processing unit 422 transmits a display instruction to the user apparatus 150 (S140). The user apparatus 150 updates and displays the sequence display IF 900 (S142).

### (6) Execution of Intended Process

It is assumed in this example that the user executes the intended process while using the user apparatus 150. An example of the intended process is “karaage” cooking shown in FIGS. 5A-5D. The user inputs the execution of the intended process to the user apparatus 150 by using the user control unit 154 of the user apparatus 150. The user apparatus 150 transmits an instruction signal for requesting the execution of the intended process to the information processing apparatus 400 in response to input from the user. The instruction signal includes, for example, information indicating the detail of the intended process.

The communication unit 410 of the information processing apparatus 400 receives the instruction signal from the user apparatus 150. The reception unit 420 receives the instruction signal and extracts information indicating the detail of the intended process from the instruction signal. The main processing unit 422 transmits a request for outputting the functional block sequence 120 according to the detail of the intended process to the sequence DB 440. The sequence DB 440 transmits the corresponding functional block sequence 120 to the main processing unit 422 in response to the output request. The main processing unit 422 receives the functional block sequence 120 from the sequence DB 440. The functional block sequence 120 is, for example, the functional block sequence 120 for “karaage” cooking shown in FIG. 5A.

The main processing unit 422 checks the flag of the functional block 110 included in the functional block sequence 120 received from the sequence DB 440 and selects the functional block 110 having the flag indicating the first type functional block 110. The main processing unit 422 causes information related to the selected functional block 110 to be transmitted from the communication unit 410 to the appliance 100 as information on the functional block sequence 120 for the appliance 100.

On the other hand, the main processing unit 422 requests the evaluation formula conversion unit 424 to convert the functional block sequence 120 into the evaluation formula 800 by outputting the functional block sequence 120 received from the sequence DB 440 to the evaluation formula conversion unit 424. The evaluation formula conversion unit 424 converts the functional block sequence 120 into the evaluation formula 800. The evaluation formula conversion unit 424 outputs the evaluation formula 800 to the main processing unit 422.

By outputting the evaluation formula 800 to the image conversion unit 426, the main processing unit 422 requests the image conversion unit 426 to convert each function 802 included in the evaluation formula 800 into the image 600 and generate a movie corresponding to the evaluation formula 800. The image conversion unit 426 converts each function 802 included in the evaluation formula 800 into the image 600 based on the second correspondence maintained in advance. Alternatively, the image conversion unit 426 may not use the second correspondence and may acquire the image 600 suited to each function 802 included in the received evaluation formula 800 by Internet search. Further, the image conversion unit 426 generates a movie by concatenating a plurality of images 600. The movie shows, for example, a procedure of an operation across a plurality of steps. The image conversion unit 426 may execute an interpolation process between the images 600 when concatenating the images 600. The image conversion unit 426 outputs the images 600 and the movie to the main processing unit 422.

The main processing unit 422 requests the text conversion unit 428 to convert each function 802 included in the evaluation formula 800 into the text 850 by outputting the evaluation formula 800 to the text conversion unit 428. The text conversion unit 428 converts each function 802 included in the evaluation formula 800 into the text 850 based on the third correspondence maintained in advance. The text conversion unit 428 outputs each text 850 to the main processing unit 422. Through these processes, the main processing unit 422 acquires a movie, a plurality of images 600, and a plurality of texts 850. The main processing unit 422 causes an instruction for displaying the movie to be transmitted from the communication unit 410 to the user apparatus 150. The display instruction includes the movie but may include the text 850.

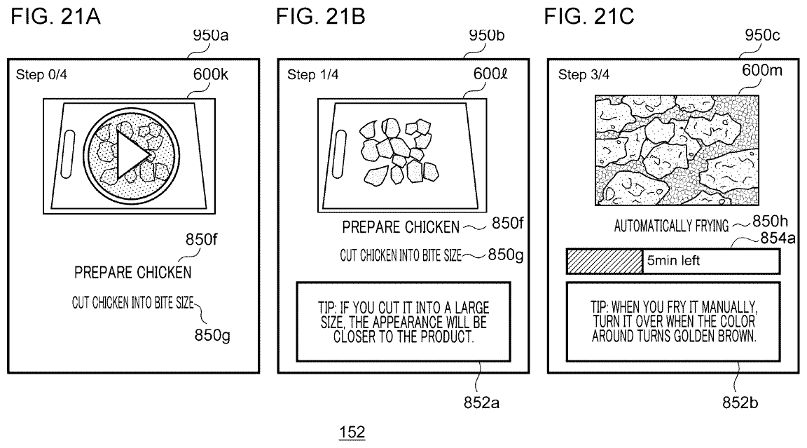

The communication unit 160 of the user apparatus 150 receives the display instruction from the information processing apparatus 400. The processing unit 156 displays a sequence display IF 950a on the display unit 152 based on the display instruction. FIGS. 21A-21C show the sequence display IF 950 displayed on the display unit 152. FIG. 21A shows the sequence display IF 950a. An image 600k (movie), a text 850f, and a text 850g are arranged in the sequence display IF 950a. The text 850f and the text 850g are, for example, the text 850 of the first step but may be omitted. By playing back the image 600k (movie), the user can check a digest of the operation procedure across a plurality of steps.

When a certain period of time has elapsed since the sequence display IF 950a is displayed, or when the user control unit 154 receives an instruction to proceed to the next step from the user, the communication unit 160 of the user apparatus 150 transmits an update signal for requesting an update to the sequence display IF 950 to the information processing apparatus 400.

The communication unit 410 of the information processing apparatus 400 receives the update signal from the user apparatus 150. When the reception unit 420 receives the update signal, the main processing unit 422 selects, of the plurality of images 600 and the plurality of texts 850 acquired, the image 600 and the text 850 of the first step. The main processing unit 422 causes a display instruction for displaying the image 600 and the text 850 of the first step to be transmitted from the communication unit 410 to the user apparatus 150.

The communication unit 160 of the user apparatus 150 receives the display instruction from the information processing apparatus 400. The processing unit 156 displays the sequence display IF 950b on the display unit 152 based on the display instruction. FIG. 21B shows the sequence display IF 950b. An image 600l of the first step, the text 850f of the first step, and the text 850g of the first step are arranged in the sequence display IF 950b. Further, a tip 852a such as “If you cut it into a large size, the appearance will be closer to the product” may be arranged in the sequence display IF 950b. This tip 852a is advice from the viewpoint of “supporting minimum implementation of the recipe” in the case the user is a beginner. For example, the tip may relate to a method of mixing seasonings. Further, the tip 852a may be advice from the viewpoint of “further increasing the level” in the case the user is an advanced user. For example, the tip may relate to a secret ingredient of a special seasoning.

To display the tip 852a like this, the user's level is stored in the storage unit 408 of the information processing apparatus 400, and the main processing unit 422 selects the detail of the tip 852a by referring to the level stored in the storage unit 408. Further, the main processing unit 422 includes the tip 852a, for which the detail is selected, in the display instruction.

When a certain period of time has elapsed since the sequence display IF 950b is displayed, or when the user control unit 154 receives an instruction to proceed to the next from the user, the communication unit 160 of the user apparatus 150 transmits an update signal to the information processing apparatus 400.

The communication unit 410 of the information processing apparatus 400 receives the update signal from the user apparatus 150. When the reception unit 420 receives the update signal, the main processing unit 422 selects, of the plurality of images 600 and the plurality of text 850 acquired, the image 600 and the text 850 of the second step. The subsequent process is the same as described above, and the image 600 and the text 850 of the second step are arranged in the sequence display IF 950 displayed on the display unit 152 of the user apparatus 150. Further, by repeating the same process, the sequence display IF 950 in which the image 600 and the text 850 of the third step are arranged and the sequence display IF 950 in which the image 600 and the text 850 of the fourth step are arranged are displayed in order on the display unit 152 of the user apparatus 150.

In a sequence display IF 950C shown in FIG. 21C, an image 600m and a text 850h of the third step are arranged. Further, a tip 852b corresponding to the third step is also arranged in the sequence display IF 950C. Further, the sequence display IF 950c also shows a progress of cooking 854a for informing the progress of the third step. The progress of cooking 854a includes a progress bar by way of example. The progress bar is a horizontal bar that is gradually filled with color according to the progress of the third step. That is, the remaining time in the third step is indicated by the progress bar. Further, the progress of cooking 854a may indicate the remaining time in the third step as a character.

The main processing unit 422 of the information processing apparatus 400 monitors the remaining time in the third step by measuring the time since the third step is started and transmits the remaining time to the user apparatus 150 via the communication unit 410. The processing unit 156 of the user apparatus 150 updates the display of the progress of cooking 854a based on the remaining time received by the communication unit 160. The update to the display of the progress of cooking 854a is, for example, a color fill in the progress bar or a change in the character “5 min”. An update to the display of the progress of cooking 854a may be made by the main processing unit 422.

The progress of cooking 854a may show a “situation that changes during cooking” such as the temperature in the pot. In that process, a temperature change is indicated by a color, or a step of boiling water is represented in an image. Alternatively, a numerical value of a changed parameter may be displayed. The main processing unit 422 of the information processing apparatus 400 transmits the temperature received from the temperature sensor provided in the appliance 100 to the user apparatus 150 via the communication unit 410. The processing unit 156 of the user apparatus 150 updates the display of the progress of cooking 854a based on the temperature received by the communication unit 160. The progress of cooking 854a may indicate a change in a parameter other than temperature.

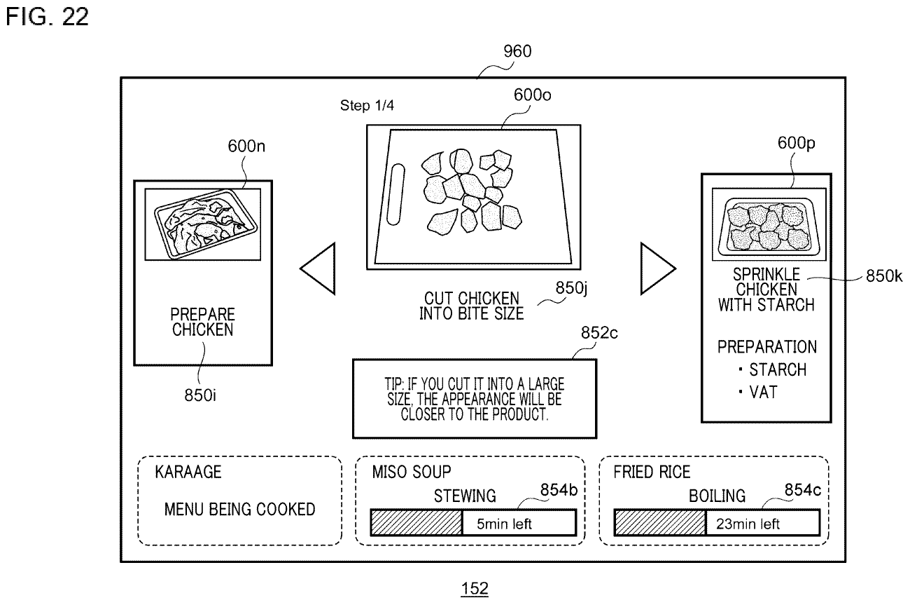

The sequence display IF 950 has been displayed for each step so far. However, the display in the display unit 152 is not limited to this. FIG. 22 shows a sequence display IF 960 displayed on the display unit 152. Images 600 and texts 850 corresponding to a plurality of (e.g., three) steps are arranged in the sequence display IF 960. In the lateral central portion of the sequence display IF 960, an image 600o and a text 850j corresponding to the current step are arranged. Further, a tip 852c corresponding to the current step is arranged on the lower side of the text 850j. In the left portion of the sequence display IF 960, an image 600n and a text 850i corresponding to the immediately preceding step are arranged. On the right side of the sequence display IF 960, an image 600p and a text 850k corresponding to the immediately subsequent step are arranged. In the sequence display IF 960, too, a progress of cooking 854b and a progress of cooking 854c are shown in the same manner as the progress of cooking 854a in FIG. 21C. The sequence display IF 960 like this is also generated by the main processing unit 422 of the information processing apparatus 400 and transmitted to the user apparatus 150.

### (7) Variation

For user convenience, the image or the movie displayed on the display unit 152 of the user apparatus 150 when the user executes the intended process may be as follows.

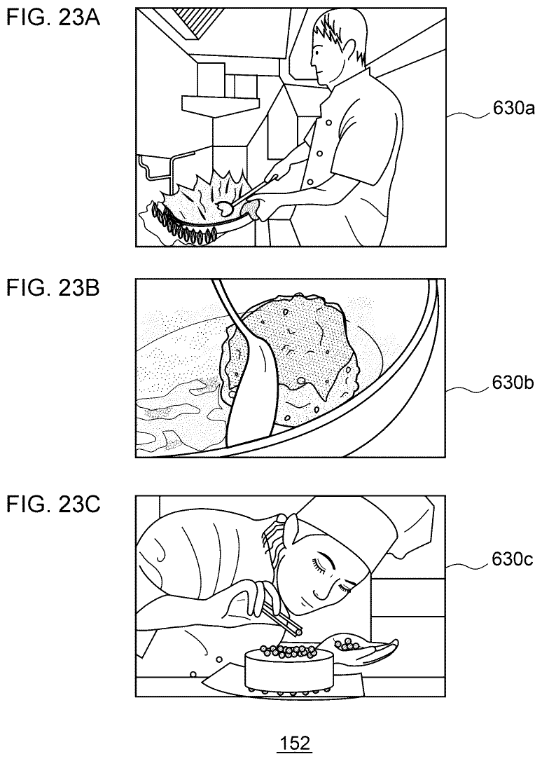

FIGS. 23A-23C show exemplary images 630 displayed on the display unit 152. Images 630a to 630c are all movies of a scene during cooking. The images 630a to 630c may be stored in advance in the storage unit 408 of the information processing apparatus 400 in association with the function 802 or may be acquired by Internet search. Further, the main processing unit 422 or the image conversion unit 426 may acquire the image of the previous step and the image of the subsequent step from the storage unit 408 or the Internet and may generate the movie by interpolating between the image of the previous step and the image of the subsequent step. The information processing apparatus 400 transmits a display instruction including the image 630 to the user apparatus 150.

The display of the image 630 on the display unit 152 of the user apparatus 150 allows the user to know the outline of cooking, check a cooking utensil to be prepared, and check the procedure during cooking. The outline of cooking is, for example, whether the ingredient is simmered or grilled or the difficulty of the manual part: whether the user can do it himself or herself/whether it is easy/whether it takes time, etc. The cooking utensil to be prepared is, for example, the type and size of a cutting board, bowl, plate, etc.

The image 630 may be any of “a short movie showing only a highlight”, “a movie explaining the entire cooking in real time”, or “a movie explaining only complicated parts of cooking”. In addition, the image 630 may be provided with playback functions such as “repeated playback of important parts” and “synchronous playback coordinated with an automatic cooker” (explanation of the manual part given immediately before the manual part, etc.). The image 630 may be devised to make the dish look delicious or to make it easier to understand how to cook. This includes, for example, “brightness, color adjustment” and “additional superimposition of explanatory text”.

In the images 630a and 630c, the cooking scene is generated from an objective point of view. In that process, “CG (Computer Graphics) model and motion data”, “synthesis with existing photographs”, and “visualization of tableware, cooking utensils owned by the user” may be used. In the second image 630b, the cooking scene is generated from a subjective point of view. In that process, “VR (Virtual Reality)-like image generation from the user's point of view” may be used.

The user's preference is registered in the storage unit 408 of the information processing apparatus 400, and the main processing unit 422 may change the image 600 and the text 850 according to the preference. In the case of a user who likes idols, for example, the image 630 showing an idol cooking is displayed, or the explanatory text 850 is displayed in an idol style. Further, the displayed proportion of the image 600 or the text 850 can be changed according to the user's preference. Such services may be available only to fan club users.

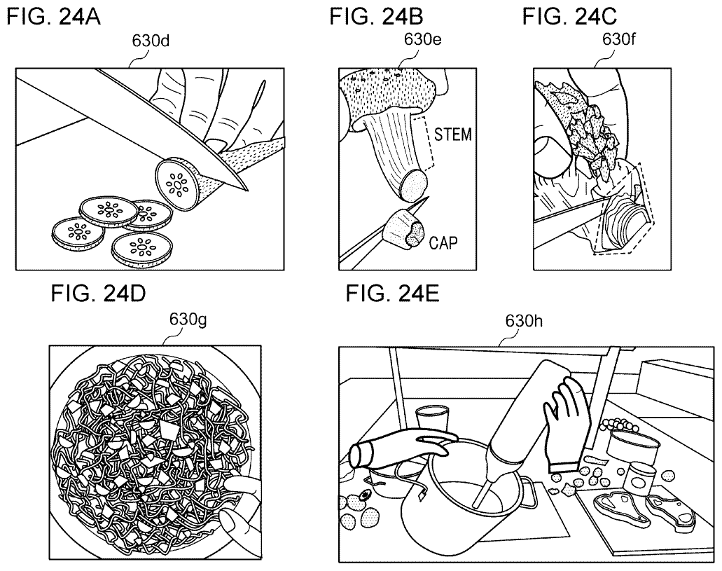

FIGS. 24A-24E show exemplary images 630 displayed on the display unit 152. In the case the image 630 is represented in CG, the direction of the image 630 is changed according to the situation. When it is desired to show the manner of holding the ingredient and the manner of holding a kitchen knife as well, an image 630d from a distanced position is used as shown in FIG. 24A. When it is desired to show a cut portion, enlarged images 630e and 630f are used as shown in FIGS. 24B and 24C. When it is desired to show a cooking flow as shown in FIG. 24D, an image 630g from above is used. In the case of a subjective viewpoint as shown in FIG. 24E, an image 630h showing the hand of a cooker as well is used. The image conversion unit 426 acquires these images 630 by converting the function 802 included in the evaluation formula 800.

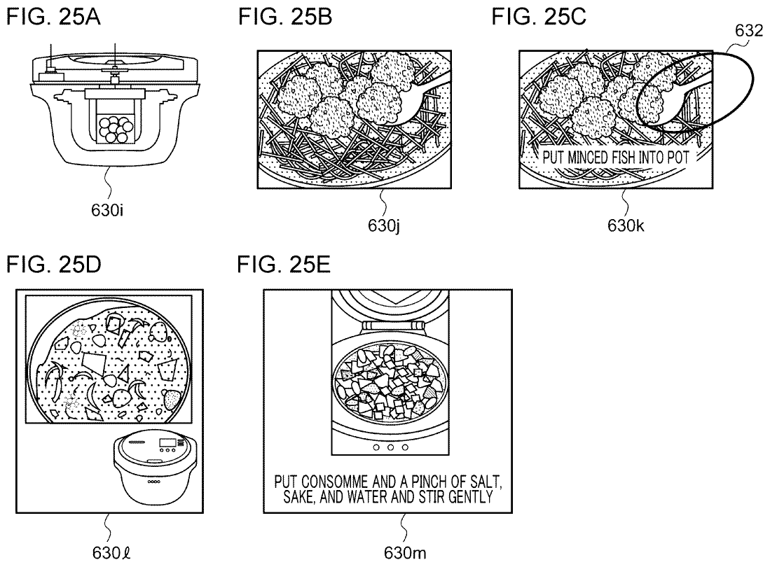

FIGS. 25A-25E show exemplary images 630 displayed on the display unit 152. In an image 630i of FIG. 25A, the condition inside the cooking utensil is shown by a CG-like representation such as translucence and partial cut.

In an image 630j as shown in FIG. 25B, it is difficult to know which portion is a point of change in the step shown. Therefore, the main processing unit 422 may show an outline presentation 632 in a point of change and show a comment, as in the case of an image 630k of FIG. 25C. A point of change in a new step may be highlighted. The main processing unit 422 generates the image 630k by superimposing, based on the function 802, the outline presentation 632 on the image 630e produced by conversion in the evaluation formula conversion unit 424.

The information processing apparatus 400 may change the representation in a portion where a manual flag is on. An image 630l in FIG. 25D is presented when automatic cooking is proceeding. For example, a video of cooking in a pot is shown. An image 630m in FIG. 25E is a presented when manual cooking is proceeding, and a tutorial is also shown at the bottom of the screen. A flag set in the functional block 110 is used to switch the image 630 depending on whether automatic cooking or manual cooking is proceeding. When the evaluation formula conversion unit 424 converts the functional block 110 into the function 802, the flag information is retained. When converting the function 802 of the evaluation formula 800 into the image 630, the image conversion unit 426 determines the image 630 by referring to the information of the flag.

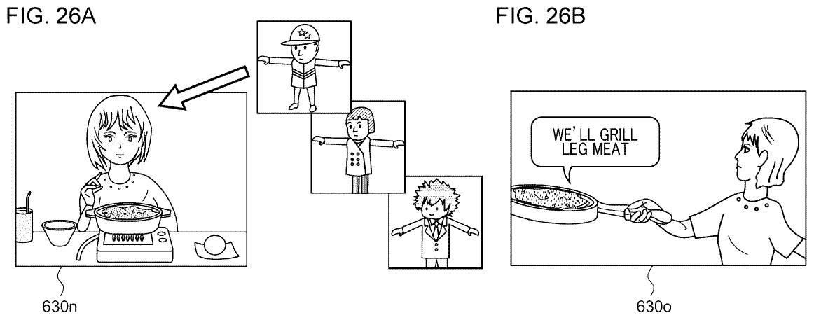

FIGS. 26A-26B show exemplary images 630 displayed on the display unit 152. In images 630n and 630o, cooking with a cooker is personified. The main processing unit 422 or the image conversion unit 426 generates the moving image 630n and the image 630o that are movies showing a character personifying a machine cooking instead of showing a pot automatically cooking. Since CG is used for the character, the character can be replaced by arbitrary data.

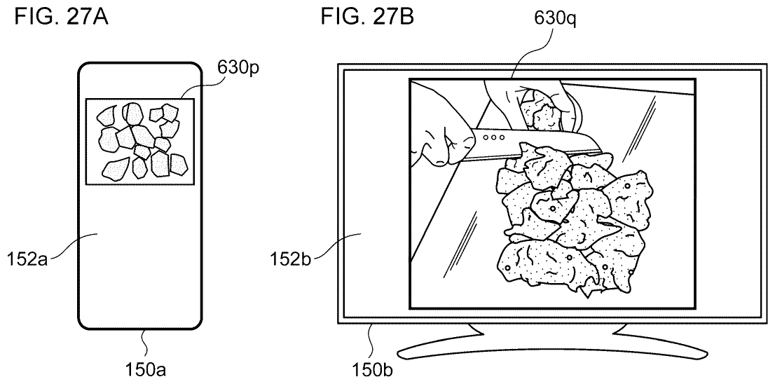

FIGS. 27A-27B show an appearance of the user apparatus 150. A user apparatus 150a shown in FIG. 27A is, for example, a smartphone, and a user apparatus 150b shown in FIG. 27B is, for example, a television receiver. Since the television receiver is larger than the smartphone, the size of a display unit 152b of the user apparatus 150b is larger than the size of a display unit 152a of the user apparatus 150a.

The main processing unit 422 acquires information related the size of the display unit 152 in the user apparatus 150. The information related to the size shows the size of the display unit 152. Further, classification such as large, medium, and small is predefined according to the size, and the information related to size may indicate either large, medium, or small. Classification of size is not limited to large, medium, and small. The main processing unit 422 outputs the information related to the size to the image conversion unit 426. The image conversion unit 426 changes the image 630 according to the information related to the size.

FIG. 27A shows an image 630p displayed when the size is small. The image 630p is a detailed image 630 showing only a target portion. The image 630p is displayed on the display unit 152a of the user apparatus 150a. FIG. 27B shows an image 630q displayed when the size is medium or large. The image 630q is the image 630 that also includes an area around the target portion. The image 630q is displayed on the display unit 152b of the user apparatus 150b.

According to the embodiment, information related to a step is displayed in a step by step manner based on one or more functions 802 included in the evaluation formula 800 so that the information related to the step can be displayed in various formats. Further, since the information related to the step is displayed in various formats, the function/operation of the appliance 100 can be displayed in an easy-to-understand manner. Further, conversion between and the evaluation formula 800 and each of the functional block sequence 120, the sequence image 620, and the sequence text 860 is possible so that conversion between the functional block sequence 120, the sequence image 620, and the sequence text 860 can be executed by way of the evaluation formula 800. Further, since conversion between the functional block sequence 120, the sequence image 620, and the sequence text 860 is executed by way of the evaluation formula 800, format change can be easily executed.

Further, since format conversion is easily executed, the sequence image 620 or the sequence text 860 corresponding to the functional block sequence 120 can be displayed. Further, since the sequence image 620 or the sequence text 860 corresponding to the functional block sequence 120 is displayed, the function/operation of the appliance 100 can be displayed in an easy-to-understand manner. Further, the image 600 representing a result of a step is displayed as the information related to the step so that the function/operation of the appliance 100 can be displayed in an easy-to-understand manner. Further, the image 600 representing the progress of the step is displayed as the information related to the step so that the function/operation of the appliance 100 can be displayed in an easy-to-understand manner. Further, the image 600 representing a state in which the step can be executed is displayed as the information related to the step so that the function/operation of the appliance 100 can be displayed in an easy-to-understand manner. Further, the text 850 representing the detail of the step is displayed as the information related to the step so that the function/operation of the appliance 100 can be displayed in an easy-to-understand manner. Further, a movie representing an operation procedure across a plurality of steps is displayed so that the procedure of the entirety of the plurality of steps can be made known in an easy-to-understand manner. Further, the functional block sequence 120 converted from the evaluation formula 800 is displayed so that various formats of display can be executed.

A summary of an embodiment of the present disclosure is given below. A display method according to an embodiment of the present disclosure includes: acquiring an evaluation formula (800) in which one or a plurality of functions (802) representing a step executed by an appliance (100) or a person and receiving a start condition, an execution parameter, and a completion condition as input variables are arranged; and displaying information related to the step in a step by step manner, based on one or a plurality of functions (802) included in the evaluation formula (800) acquired.

The information related to the step may be an image (600) or a movie representing a result of the step.

The information related to the step may be an image (600) or a movie representing a progress of the step.

The information related to the step may be an image (600) or a movie representing a state in which the step is executable.

The information related to the step may be a text (850) representing a detail of the step.

The displaying of the information related to the step in a step by step manner includes displaying a movie showing a procedure of an operation across a plurality of steps.

The displaying of the information related to the step in a step by step manner includes displaying a block (110) defined in a functional unit that the appliance (100) is adapted to execute or displaying a block sequence (120) in which a block (110) defined in a unit of operation to be executed by a person is arranged in an order of operation.

Another embodiment of the present disclosure relates to an information processing apparatus. The apparatus includes: a first processor that acquires an evaluation formula (800) in which one or a plurality of functions (802) representing a step executed by an appliance (100) or a person and receiving a start condition, an execution parameter, and a completion condition as input variables are arranged; and a second processor that displays information related to the step in a step by step manner, based on one or a plurality of functions (802) included in the evaluation formula (800) acquired.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

The image 600 in this embodiment represents a state in which the step can be executed, a progress of the step, or a result of the step. Alternatively, however, the image 600 may be, for example, a movie. This movie may represent a state in which the step can be executed, a progress of the step, or a result of the step. In the process involving the image 600 described so far, the image 600 may be replaced by a move. According to this variation, the flexibility of the configuration can be improved.

In (5) update to functional block sequence of the embodiment, the user uses the user control unit 154 of the user apparatus 150 to update the sequence image 620 by changing the image 600 or the auxiliary image 610 of the sequence image 620 arranged in the image display area 906 (FIG. 18). The updated sequence image 620 is transmitted from the user apparatus 150 to the information processing apparatus 400 as updated information. The image conversion unit 426 of the information processing apparatus 400 converts the updated sequence image 620 into the evaluation formula 800 using the second correspondence, and the evaluation formula conversion unit 424 converts the evaluation formula 800 into the functional block sequence 120 using the first correspondence.

Alternatively, however, the information processing apparatus 400 may receive image data, the image conversion unit 426 may convert the image data into the evaluation formula 800, and the evaluation formula conversion unit 424 may convert the evaluation formula 800 into the functional block sequence 120 at the stage of (4) creation of functional block sequence. In this case, the image data is, for example, read into the application program of the user apparatus 150 in the form of a QR code (registered trademark) and transmitted from the user apparatus 150 to the information processing apparatus 400. According to this variation, the functional block sequence 120 is created from the image data so that user convenience can be improved.

Further, when the information processing apparatus 400 acquires information on the available appliance 100 at the stage of (4) creation of functional block sequence, the main processing unit 422 may create the functional block sequence 120 according to the available appliance 100. In that process, the storage unit 408 stores correspondence between the available appliance 100 and the functional block sequence 120 in advance. Further, when there are a plurality of functional block sequences 120 corresponding to the available appliance 100, one functional block sequence 120 may be selected by the user. According to this variation, the functional block sequence 120 is created from the information on the available appliance 100 so that user convenience can be improved.

What is claimed is:

1. A display method comprising:
acquiring an evaluation formula in which one or a plurality of functions representing a step executed by an appliance or a person and receiving a start condition, an execution parameter, and a completion condition as input variables are arranged; and
displaying information related to the step in a step by step manner, based on one or a plurality of functions included in the evaluation formula acquired.

2. The display method according to claim 1,
wherein the information related to the step is an image or a movie representing a result of the step.

3. The display method according to claim 1,
wherein the information related to the step is an image or a movie representing a progress of the step.

4. The display method according to claim 1,
wherein the information related to the step is an image or a movie representing a state in which the step is executable.

5. The display method according to claim 1,
wherein the information related to the step is a text representing a detail of the step.

6. The display method according to claim 1,
the displaying of the information related to the step in a step by step manner includes displaying a movie showing a procedure of an operation across a plurality of steps.

7. The display method according to claim 1,
the displaying of the information related to the step in a step by step manner includes displaying a block defined in a functional unit that the appliance is adapted to execute or displaying a block sequence in which a block defined in a unit of operation to be executed by a person is arranged in an order of operation.

8. An information processing apparatus comprising:
a first processor that acquires an evaluation formula in which one or a plurality of functions representing a step executed by an appliance or a person and receiving a start condition, an execution parameter, and a completion condition as input variables are arranged; and
a second processor unit that displays information related to the step in a step by step manner, based on one or a plurality of functions included in the evaluation formula acquired.

9. A program comprising computer-implemented modules including:
a module that acquires an evaluation formula in which one or a plurality of functions representing a step executed by an appliance or a person and receiving a start condition, an execution parameter, and a completion condition as input variables are arranged; and
a module that displays information related to the step in a step by step manner, based on one or a plurality of functions included in the evaluation formula acquired.
